(19) United States
(12) Patent Application Publication
(10) Pub. No.: US 2015/0149619 A1
(43) Pub. Date: May 28, 2015

(54) USER STATE CONFIRMATION SYSTEM, USER STATE CONFIRMATION METHOD, SERVER DEVICE, COMMUNICATION TERMINAL DEVICE, SERVER COMPUTER PROGRAM, AND TERMINAL COMPUTER PROGRAM

(71) Applicant: Sharp Kabushiki Kaisha, Osaka-shi, Osaka (JP)

(72) Inventors: Keisuke Tsuji, Osaka-shi (JP); Daiki Ogasawara, Osaka-shi (JP); Jun Sasaki, Osaka-shi (JP)

(73) Assignee: Sharp Kabushiki Kaisha, Osaka-shi, Osaka (JP)

(21) Appl. No.: 14/409,570

(22) PCT Filed: Jun. 13, 2013
(86) PCT No.: PCT/JP2013/066317

§ 371 Date: Dec. 19, 2014

(30) Foreign Application Priority Data
Jun. 21, 2012 (JP) 2012-139710
Mar. 29, 2013 (JP) 2013-071884

(51) Int. Cl. H04L 29/08

(52) U.S. Cl. CPC H04L 67/22
USPC 709/224

(57) ABSTRACT

In order to remotely confirm a state of monitored person without using monitoring sensors, a user state confirmation system (1) communicatively connects a television device (10) (with communication function) used by the user on a day-to-day basis, to a server device (2) providing a watching service. Based on a power-on operation by the user, the television device (10) transmits the power-on information to the server device (2), and the server device (2) stores the received power-on information together with date and time of the reception. Further, based on the power-on operation, the television device (10) displays a question page, and transmits information indicating the answer from the user to the server device (2), and the server device (2) stores the information indicating the answer from the user together with the date and time of reception. The state of monitored person can be confirmed by referring to various types of information stored in the server device (2).

### TECHNICAL FIELD

The present disclosure relates to a user state confirmation system, a user state confirmation method, a server device, a communication terminal device (for example, a television device provided with a communication function), a server computer program, and a terminal computer program, for enabling remote confirmation of a user state without providing a number of various sensors, by cooperatively utilizing a communication terminal device used by a user on a day-to-day basis with a cloud service provided by a server device.

### BACKGROUND ART

Conventionally, a number of systems for enabling the remote confirmation of state of person living remotely is provided. Patent Document 1 as described below discloses a system with a plurality of monitoring sensors installed in a house of a monitored person to be confirmed, so that the state of the person can be remotely confirmed and monitored via a communications network. Moreover, as a well-known art, a system is known in which sensors for detecting using states of appliances and devices provided in a house are attached to each of the appliances and devices so that the safety of persons living in the house can be confirmed by transmitting detection results of the sensors to a monitoring side via communication terminal devices and a communications network. Examples of such sensors include a sensor for detecting on/off of an electric lamp, a sensor for detecting open/close of a refrigerator, and a sensor for detecting water flushing of toilet.

### REFERENCE DOCUMENTS OF CONVENTIONAL ART

### Patent Documents

[Patent Document 1] JP2002-324291A

### DISCLOSURE OF THE INVENTION

### Problems to be Solved by the Invention

According to the system of Patent Document 1 and the well-known art as described above, since a number of various sensors is required, these sensors must be installed at necessary positions in the house. Moreover, in general, the sensor itself has no communication function, and in the case that the sensor is attached to an appliance or a device used by a user (for example, electric lamp, refrigerator or toilet), in general, such an appliance or a device has no communication function, and therefore, the sensor must be connected to a communication apparatus so that the detection result of the sensor can be transmitted. Therefore, since the effort and cost are required for installing a number of sensors and for transmitting the detection results of the sensors, the construction of conventional remote monitoring system becomes grandiose, and such a system cannot be easily introduced to standard household.

Moreover, in general, since the detection result of each sensor remains in a binary result whether or not the detection is made, it is impossible to remotely confirm minute changes of a user such as the mental and health conditions. In addition, from the viewpoint of the monitoring side, it is desired to confirm firstly and quickly whether or not the user is alive, at major moments of monitoring such as the change of the date.

In the light of the situations as described above, the purpose of the present disclosure is to provide a user state confirmation system, a user state confirmation method, a server device, a communication terminal device (for example, a television device provided with a communication function), a server computer program, and a terminal computer program, for enabling remote confirmation of a user state without using various sensors, by utilizing a communication terminal device originally provided with a communication function, so that information indicating the response from a user such as the using state, etc., of the communication terminal device, is transmitted to the server device at appropriate timings.

Furthermore, another purpose of the present disclosure is to provide a user state confirmation system, a user state confirmation method, a server device, a communication terminal device (for example, a television device provided with a communication function), and a computer program, for enabling confirmation of a user state more in detail than the conventional arts, by outputting a question from a communication terminal device, to be answered from a plurality of selective answers.

In addition, another purpose of the present disclosure is to provide a user state confirmation system, a user state confirmation method, a server device, a communication terminal device, a server computer program, and a terminal computer program, in which, before outputting the question, by outputting a preceding output from the communication terminal device that can be responded by the user, whether or not the user responds to the preceding output can be quickly grasped by a monitoring side as a life state confirmation.

### Means for Solving the Problems

To solve the above situations, a user state confirmation system of the present disclosure is provided, which includes a server device and a communication terminal device, enabling remote confirmation of a state of a user operating the communication terminal device, through the server device receiving information of the state of a user operating the communication terminal device. The communication terminal device includes a transmitter configured to transmit a power-on information to the server device indicating that the power is on when a power-off state transits to a power-on state based on a power-on operation, an outputter configured to output a first question to the user based on the power-on operation, and a transmitter configured to transmit a first response information to the server device indicating a response from the user to the outputted first question. The server device includes a memory configured to store the power-on information associated with date and time of reception at which the power-on information is received, a memory configured to store the first response information associated with date and time of reception at which the first response information is received, and a reader/outputter configured to read and output stored information.

Further, in the user state confirmation system of the present disclosure, the server device may store a plurality of second question candidates. The server device may include a selector configured to select a second question candidate from the plurality of second question candidates based on the received first response information, and a reader/transmitter configured to read and transmit the selected second question candidate, as a second question, to the communication terminal device. The communication terminal device may include a transmitter configured to transmit a second response information to the server device indicating a response from the user to the received second question. The server device may further include a memory configured to store the second response information associated with date and time of reception at which the second response information is received.

Further, in the user state confirmation system of the present disclosure, wherein, the server device may store the first question, and the server device may include a reader/transmitter configured to read and transmit the stored first question to the communication terminal device when receiving the power-on information. The communication terminal device may be configured to output the received first question.

Moreover, in the user state confirmation system of the present disclosure, the server device may store a threshold time period and the server device may include a timer configured to measure time from transmission of the first question. The server device may be configured to store the first response information, when the measured time does not exceed the threshold time period, and also when the first response information is received. The server device may be configured to store a fact of no response to the first question, when the first response information is not received, and also when the measured time exceeds the threshold time period.

Furthermore, in the user state confirmation system of the present disclosure, the communication terminal device may store the first question, and the communication terminal device may be configured to read and output the stored first question based on the power-on operation.

Also, in the user state confirmation system of the present disclosure, the first question may include a plurality of first questions, and the server device may store some of the first questions. The server device may include a reader/transmitter configured to read and transmit stored some of the first questions to the communication terminal device when the power-on information is received. The communication terminal device may store other first questions, and the communication terminal device may be configured, when some of the first questions are received, to read the stored other first questions and output a combination of some of the first questions with the other first questions.

In addition, in the user state confirmation system of the present disclosure, the communication terminal device may store a threshold time period, and the communication terminal device may include a display, an outputter configured to display the first question on the display, a timer configured to measure time from indication of the first question on the display, and a comparator configured to compare whether or not the measured time exceeds the threshold time period. The communication terminal device may be configured, when the measured time does not exceed the threshold time period, and also when an answer to the first question is received, to transmit the first response information indicating the answer, and the communication terminal device may be configured, when the measured time exceeds the threshold time period without receiving the answer to the first question, to transmit the first response information indicating the fact of no response to the first question.

Also, in the user state confirmation system of the present disclosure, the server device may includes a transmitter configured to transmit a notice information to the communication terminal device indicating contents to be notified to the user when the power-on information is received. The communication terminal device may be configured to output the received notice information on the display together with the first question.

Further, in the user state confirmation system of the present disclosure, the communication terminal device may be a television device including communication function.

Further, in the user state confirmation system of the present disclosure, the communication terminal device may include a preceding outputter configured to output a preceding output enabling the user to respond prior to the first question based on the power-on operation, and an operation receiver capable of receiving the user responding operation in response to the preceding output. The communication terminal device may be configured to output the first question when the operation receiver receives the user responding operation.

Furthermore, in the user state confirmation system of the present disclosure, the communication terminal device may include a transmitter configured to transmit a notice of the user responding operation reception to the server device when the operation receiver receives the user responding operation.

In the user state confirmation system of the present disclosure, the communication terminal device may store a reference time period, and the communication terminal device may include a transmitter configured to transmit a notice of no user responding operation to the server device, when the time from outputting of the preceding output by the preceding outputter exceeds the reference time period, and also when the operation receiver does not receive the user responding operation.

In the user state confirmation system of present disclosure, the preceding outputter may be configured, when the time from outputting of the preceding output exceeds the reference time period, to stop the output, and to output the stopped output again.

Moreover, in the user state confirmation system of the present disclosure, the server device may store a server reference time period, and the server device may include a timer configured to measure time in response to reception of the power-on information, and a determinator configured to determine as no user responding operation, when the measured time exceeds the server reference time period, and also when the notice of the user responding operation reception is not received.

In the user state confirmation system of the present disclosure, the communication terminal device may store a reference time period and a reference number of times. The communication terminal device may include a transmitter configured to transmit a notice of no user responding operation to the server device, when the time from outputting of the preceding output by the preceding outputter exceeds the reference time period, and also when the operation receiver does not receive the user responding operation. The preceding outputter may be configured, when the time from outputting of the preceding output exceeds the reference time period, to stop the output, and to output the stopped output again. The communication terminal device may be configured, when the operation receiver does not receive the responding operation in response to the preceding output outputted again, to transmit the notice of no user responding operation by the transmitter, and to repeat pausing and re-outputting of the preceding output by the preceding outputter. The communication terminal device may be configured, when the number of repeats exceeds the reference number of times, to transmit a notice of the user abnormal state to the server device.

In the user state confirmation system of the present disclosure, the server device may stores a server reference time period and a server reference number of times. The server device may include a timer configured to measure time in response to reception of the power-on information, a first processor configured to determine whether or not the notice of the user responding operation reception is received, a second processor configured to transmit a notice of server reference time period excess to the communication terminal device, when the measured time exceeds the server reference time period, and also when the notice of the user responding operation reception is not received, a third processor configured to temporarily reset the measured time and start the time measurement again, when the measured time exceeds the server reference time period, and also when the notice of the user responding operation reception is not received, a repeater configured to repeat processing from the first processor to the third processor unless the notice of the user responding operation reception is received, a transmitter configured to transmit a notice of server reference number of times excess when the number of repeats exceeds the server reference number of times, and a determinator configured to determine as a user abnormal state when the number of repeats exceeds the server reference number of times. The communication terminal device may be configured, when the notice of server reference time period excess is received, to stop outputting of the preceding output by the preceding outputter, and to output the stopped preceding output again. The communication terminal device may be configured, when the notice of server reference number of times excess is not received in response to the preceding output outputted again, to repeat pausing and re-outputting of the preceding output by the preceding outputter, as in the case of receiving the notice of the server reference time period excess.

In the user state confirmation system of the present disclosure, the server device may store data of the preceding output, and the server device may include a reader/transmitter configured to read and transmit the stored data of the preceding output to the communication terminal device when the power-on information is received. The communication terminal device may be configured to output the preceding output by the preceding outputter based on the received data of the preceding output.

In the user state confirmation system of the present disclosure, the communication terminal device may store data of the preceding output, and the communication terminal device may be configured to read the stored data of the preceding output based on the power-on operation, and to output the preceding output by the preceding outputter based on the read data of the preceding output.

In the user state confirmation system of the present disclosure, the preceding outputs may include a plurality of elements. The server device may stores data of some of the plurality of elements, and the server device may includes a reader/transmitter configured to read and transmit the stored data of the some of the plurality of elements to the communication terminal device when the power-on information is received. The communication terminal device may store data of other elements, and the communication terminal device may be configured, when receiving the data of some of the plurality of elements, to read the stored data of other elements and to output the preceding output by the preceding outputter based on the received data of some of the plurality of elements and the read data of the other elements.

Moreover, a method of confirming a user state of the present disclosure is provided for enabling remote confirmation of a state of the user operating a communication terminal device, through a server device receiving information of the state of the user operating the communication terminal device. The method includes, by the communication terminal device, transmitting power-on information to the server device indicating that the power is on when a power-off state transits to a power-on state based on a power-on operation, outputting a first question to the user based on the power-on operation, transmitting a first response information to the server device indicating a response from the user to the outputted first question. The method includes, by the server device, storing the power-on information associated with date and time of reception at which the power-on information is received, storing the first response information associated with date and time of reception at which the first response information is received, and reading and outputting stored information.

The user state confirmation method of the present disclosure may include, by the communication terminal device, outputting a preceding output capable of the user responding operation prior to the first question based on the power-on operation, and performing an operation reception to receive the user responding operation in response to the preceding output. The communication terminal device may be configured to output the first question when the user responding operation is received while performing the operation reception.

Further, a sever device of the present disclosure is provided for enabling confirmation of a state of a user operating an external communication terminal device, through receiving information of the state of the user operating the external communication terminal device. The sever device includes a memory configured to store power-on information indicating that the power is on, associated with date and time of reception at which the power-on information transmitted from the external communication terminal device is received, a memory configured to store first response information indicating a response from the user to the first question, associated with date and time of reception at which the first response information transmitted from the external communication terminal device is received, and a reader/outputter configured to read and output stored information.

Furthermore, the server device of the present disclosure may store a plurality of second question candidates, and the server device may include a selector configured to select a second question candidate from the plurality of second question candidates based on the received first response information, a reader/transmitter configured to read and transmit the selected second question candidate, as a second question, to the external communication terminal device, and a memory configured to store second response information indicating a response from the user to the second question, associated with date and time of reception at which the second response information transmitted from the external communication terminal device is received in response to the transmission of the second question.

In addition, the server device may store the first question, and the server device may include a reader/transmitter configured to read and transmit the stored first question to the external communication terminal device when the power-on information is received.

Moreover, a user state confirmation method of the present disclosure is provided for enabling confirmation of a state of user operating an external communication terminal device, through a server device receiving information of the state of user operating the external communication terminal device. The method includes, by the server device, storing power-on information associated with date and time of reception at which the power-on information transmitted from the external communication terminal device indicating that the power is on is received, storing first response information associated with date and time of reception at which the first response information transmitted from the external communication device indicating a response from the user to a first question is received, and reading and outputting stored information.

A communication terminal device of the present disclosure is provided which is capable of communicating with an external server device. The communication terminal device includes a transmitter configured to transmit power-on information by using the communication function, to the external server device indicating that the power is on when a power-off state transits to a power-on state based on a power-on operation, an outputter configured to output a first question on a display screen to a user based on a power-on operation, and a transmitter configured to transmit a first response information by using the communication function, to the external server device indicating a response from the user to the outputted first question.

Further, the communication terminal device of the present disclosure may store a threshold time period. The communication terminal device may include an outputter configured to display the first question on the display screen, a timer configured to measure time from indication of the first question, and a comparator configured to compare whether or not the measured time exceeds the threshold time period. The communication terminal device may be configured, when the measured time does not exceed the threshold time period, and also when an answer to the first question is received, to transmit the first response information indicating the answer, and the communication terminal device may be configured, when the measured time exceeds the threshold time period without receiving the answer to the first question, to transmit the first response information indicating the fact of no response to the first question.

Further, the communication terminal device of the present disclosure may include a preceding outputter configured to output a preceding output capable of the user responding operation prior to the first question based on the power-on operation, and an operation receiver capable of receiving the user responding operation in response to the preceding output. The communication terminal device may be configured to output the first question when the operation receiver receives the user responding operation.

Furthermore, the communication terminal device of the present disclosure may include a transmitter configured to transmit a notice of the user responding operation reception to the external server device when the operation receiver receives the user responding operation.

Further, the communication terminal device of the present disclosure may store a reference time period, and the communication terminal device may include a transmitter configured to transmit a notice of no user responding operation to the external server device, when the time from outputting of the preceding output by the preceding outputter exceeds the reference time period, and also when the operation receiver does not receive the user responding operation.

Furthermore, the communication terminal device of the present disclosure, the preceding outputter may be configured, when the time from outputting of the preceding output exceeds the reference time period, to stop the output, and when the notice of no user responding operation is transmitted to the external server device, to output the preceding output again.

The communication terminal device of the present disclosure may store a reference time period and a reference number of times. The communication terminal device may include a transmitter 1 configured to transmit a notice of no user responding operation to the external server device, when the time from outputting of the preceding output by the preceding outputter exceeds the reference time period, and also when the operation receiver does not receive the user responding operation. The preceding outputter may be configured, when the time from outputting of the preceding output exceeds the reference time period, to stop the output, and when the notice of no user responding operation is transmitted to the external server device, to output the preceding output again. The communication terminal device may be configured, when the operation receiver does not receive the responding operation in response to the preceding output outputted again, to transmit the notice of no user responding operation by the transmitter, and to repeat pausing and re-outputting of the preceding output by the preceding outputter. The communication terminal device may be configured, when the number of repeats exceeds the reference number of times, to transmit a notice of the user abnormal state to the external server device.

Further, the communication terminal device of the present disclosure may store data of the preceding output, and the communication terminal device may be configured to read the stored data of the preceding output based on the power-on operation, and to output the preceding output by the preceding outputter based on the read data of the preceding output.

Further, a sever computer program is provided for causing a server computer receiving information of a state of a user operating an external communication terminal device to confirm the state of the user operating the external communication terminal device. The program causes the server computer to function as a memory configured to store power-on information indicating that power is on, associated with date and time of reception at which the power-on information transmitted from the external communication terminal device is received, a memory configured to store a first response information indicating a response from the user to a first question, associated with date and time of reception at which the first response information transmitted from the external communication terminal device is received, and a reader/outputter configured to read and output stored information.

A terminal computer program of the present disclosure is provided for causing a computer having a communication function capable of communicating with an external server to transmit a state of the user operating the computer to the external server device. The program causes the computer to function as a transmitter configured to transmit power-on information to the external server device by using the communication function indicating that the power is on when a power-off state transits to a power-on state based on a power-on operation, an outputter configured to output a first question to the user based on the power-on operation, and a transmitter configured to transmit a first response information to the external server device by using the communication function indicating a response from the user to the outputted first question.

Further, in the terminal computer program of the present disclosure, the computer may include a user interface capable of receiving a user operation. The program may cause the computer to function as a preceding outputter configured to output a preceding output capable of a user responding operation prior to the first question based on the power-on operation, and a receiver configured to receive the user responding operation in response to the preceding output via the user interface. The computer may be configured to output the first question when the user responding operation is received via the user interface.

In the present disclosure, upon the power-on operation of the user, the communication terminal device transmits the power-on information to the server device, and the server device stores the power-on information associated with date and time of the reception. Therefore, the server device can grasp the state automatically together with the date and time that the user is at least able to perform the power-on operation. Furthermore, the first response information indicating the response from the user to the first question outputted from the communication terminal device is also transmitted to the server device, and the server device stores the first response information together with date and time of the reception. Therefore, the server device can confirm the state of the user more in detail. Accordingly, in the present disclosure, by utilizing the activation, output function and communication function of the communication terminal device used by the user on a day-to-day basis, the state of the user can be confirmed remotely without using any special sensor, and thereby the system can be constructed easily. Note that, it is preferable to ask the mental or physical condition of the user as the contents of the first question, so that the mental or physical condition of the user can be confirmed remotely. Moreover, the number of questions capable of being included in the first question is not limited specifically, and the first question includes both the case of comprising one question, and the case of comprising two or more questions (for reference, the first question means, for example, the initial (first) inquiry to the user of the day). In addition, the first question outputted based on the power-on operation includes both the case of being outputted directly based on the power-on operation, and the case of being outputted based on an indirect response to the power-on operation, and as an example of indirect output, although described later, the output is performed based on the operation of the user in response to a preceding output prior to the first question.

In the present disclosure, the server device selects a second question from the plurality of second question candidates based on the first response information, and transmits the question to the communication terminal device. The communication terminal device transmits the second response information indicating the response from the user to the received second question, back to the server device. Therefore, in addition to the first question as described above, the server device can confirm the state of the user regarding the second question and confirm more detail of the state of the user. Note that, in the second question, it is preferable to ask the user about more detailed contents of the first question. For example, if the health condition is asked in the first question, and if the first response information of the user to that question is “Not good,” then the second question preferably has the contents such as “In which part do you feel unwell?” so that the user may select the answer from “Head,” “Upper body” or “Lower body.” Moreover, the number of questions capable of being included in the second question (second question candidates) is not limited specifically, and the second question (second question candidates) includes, likewise the case of the first question, both the case of comprising one question, and the case of comprising two or more questions (for reference, the second question means the inquiry to the user in a situation other than the first question (for example, the second time)).

In the present disclosure, the first question is transmitted from the server device to the communication terminal device. Therefore, the server device can change the contents of the first question, and the timely and appropriate first question can be provided to the user according to the seasons, hours, the days of the week, etc., so as to encourage the interest and motivation of the user to the first question.

In the present disclosure, the communication terminal device reads and outputs the stored first question. Therefore, the first question can be provided to the user without requiring communication with the server device, thereby the first question can be processed quickly.

Moreover, in the present disclosure, when the first question includes two or more questions, the server device stores the some of the first questions, and the communication terminal device stores the other first questions, so that the communication terminal device can output the combination of the some of the first question with the other first question as described above, as the first question. Accordingly, it is desirable that various contents of questions can be provided to the user.

In the present disclosure, the time from the indication of the first question is measured in order to compare whether or not the measured time exceeds the threshold time period or not. If there is the answer within the threshold time period, the first response information indicating the answer is transmitted, and if the threshold time period exceeds, the first response information indicating that there is no answer is transmitted. Therefore, regardless of the response from the user (including there is no answer), the first response information is transmitted to the server device, thereby the server device can proceed to further processing flexibly according to the various types of response from the user, and can also determine mental and physical conditions of the user based on the first response information.

Moreover, in the present disclosure, the server device may store the threshold time period so that the server device can determine whether or not there is the answer to the first question within the threshold time period. Accordingly, the processing load on the communication terminal device can be relieved.

In the present disclosure, the server device transmits the notice information to the communication terminal device of the user, and the communication terminal device displays the notice information transmitted from the server device together with the first question. Therefore, with the notice information providing necessary information for the user, the interest and motivation of user to the displayed first question are encouraged, and it is possible to provide the state in which the user can readily answer to the first question displayed together with the notice information.

In the present disclosure, the television device including the communication function is applied as the communication terminal device. Therefore, the state of user can be confirmed based on the television device, that is the device mostly and usually used by the user staying at home. Moreover, since the television device itself includes the communication function, the cloud service provided by the server device can be linked smoothly, and the system can be constructed easily.

In the present disclosure, the communication terminal device outputs the preceding output capable of the user responding operation prior to the first question, and the operation receiver can receive the user responding operation. Therefore, it is possible to provide the user with an opportunity to respond to the first question. Note that, as examples of the preceding output form, an indication output, an audio output, a vibration output, etc., can be applied as long as it can be recognized or perceived by human body, and any of these output forms is used for requesting the user responding operation. As examples of requesting the responding operation, an instruction or reminder to the user such as “Press the button,” a question such as “What's your fortune today?” or any type of output encouraging the user to perform the responding operation can be applied, and from the viewpoint of importance of confirmation whether or not the user is alive, first of all it is important to arrange the type of output that encourage the user to perform on his/her own motive the responding operation. Moreover, as examples of user responding operations, the operation by the user, of an operation user interface (user interface receiving the operation) provided in the communication terminal device as an example of the operation receiver, or buttons, switches of the remote controller, is applied.

In the present disclosure, when the user responding operation in response to the preceding output is received, the notice of user responding operation reception is transmitted to the server device. Therefore, the monitoring side of the user can confirm quickly that the user is able to perform the responding operation, in other words, that the user is alive.

In the present disclosure, after passing of the reference time period from outputting of the preceding output, if the user responding operation is not received, the communication terminal device transmits the notice of no user responding operation to the server device. Therefore, the monitoring side can grasp at an earlier stage that the user seems to be unwell, and can be ready easily for the case of requiring the caution, etc.

In the present disclosure, instead of continuously outputting the preceding output, the preceding output is stopped temporarily, and is outputted again. Therefore, it is possible to provide opportunities repeatedly to confirm whether or not the user is alive, and the accuracy of user state confirmation can be improved.

Moreover, in the present disclosure, the server device stores the server reference time period, and when the measured time in response to the reception of the power-on information exceeds the server reference time period, and also when the notice of the user operation reception is not received, the fact of no user responding operation is determined. Therefore, the server device determines whether or not the user operation is received, and the processing load on the communication terminal device can be reduced.

In the present disclosure, when the number of repeated re-outputs of the preceding output exceeds the reference number of times, if the notice of user responding operation reception is not received, the communication terminal device transmits the notice of the user abnormal state to the sever device. Therefore, the monitoring side can grasp the high probability of the user abnormal state at an earlier stage, and can be ready easily for coping with the monitored state.

Moreover, in the present disclosure, based on the determination of the server device, the communication terminal device repeats re-outputting of the preceding output for a number of times, and the server device determines whether or not the number of repeats exceeds the server reference number of times. Therefore, the server device can determine whether or not this is the user abnormal state, and the processing load on the communication terminal device can be reduced. Further, the server device can grasp the occurrence of the user abnormal state even in the environment incapable of transmitting the notice from the communication terminal device to the server device.

In the present disclosure, the server device transmits the data of the preceding output to the communication terminal device. Therefore, the server device can change the contents of the preceding output, and the user can be motivated to perform the responding operation easily, by preventing boredom of the user about the contents of the preceding output.

In the present disclosure, the communication terminal device stores the data of the preceding output. Therefore, the preceding output can be outputted quickly without communicating with the server device.

In the present disclosure, the server device transmits the data of the part of element constituting the preceding output to the communication terminal device, and the communication terminal device reads the data of the other part of element stored by itself, so that the preceding output is outputted based on the data of the part and the data of the other part. Therefore, various contents can be secured for the preceding output, and the user can be motivated to perform the responding operation by drawing the attention of user with the various contents.

### Effects of the Invention

In the present disclosure, by utilizing the activation, output function and communication function of the communication terminal device used by the user on a day-to-day basis, the state of user can be confirmed remotely. Therefore, various sensors lots are used in conventional systems for monitoring are no longer required, and the system for remotely confirming the state of user can be constructed more easily.

In the present disclosure, the server device selects a second question from the plurality of second question candidates based on the first response information, and transmits that question to the communication terminal device. Therefore, in addition to the response from the user to the first question, since the server device can grasp even the response from the user to the second question reflecting the response from that user, the state of user can be confirmed more in detail.

In the present disclosure, the first question is transmitted from the server device to the communication terminal device. Therefore, the server device can change the contents of the first question appropriately, and by setting various contents of the first question, the interest and motivation of the user to the first question can be encouraged.

In the present disclosure, the communication terminal device reads and outputs the stored first question. Therefore, the first question can be processed quickly without requiring communication with the server device.

In the present disclosure, the response from the user to the first question is determined from the two points of view, namely the reception of the answer or the time over. Therefore, regardless of the response from the user, the server device can proceed to further processing, and the contents of the response from the user from the above two points of view can be utilized as the material for determination of the mental and physical conditions of the user, thereby the condition of the user can be confirmed flexibly.

Moreover, in the present disclosure, when the first question includes two or more questions, the server device stores some of them, and the communication terminal device stores the other. Therefore, the first question, by combining the variable part of question according to the situation with the fixed part of question, can be provided to the user, so that the conditions (physical, mental, etc.) of the user can be confirmed more in detail.

In the present disclosure, the communication terminal device displays the notice information transmitted from the server device together with the first question. Therefore, with the notice information providing necessary information for the user, the interest and motivation of the user to the displayed page are encouraged, and it is possible to provide the state in which the user can readily answer to the first question displayed together with the notice information.

In the present disclosure, the television device including the communication function is applied as the communication terminal device. Therefore, the television device, that is the device mostly and usually used by the user staying at home, can be linked to the cloud service provided by the server device smoothly, and the difficulties in construction of the system can be relieved considerably than conventional systems.

In the present disclosure, the communication terminal device outputs the preceding output prior to the first question, and the operation receiver can receive the user responding operation in response to the preceding output. Therefore, without waiting for the answer to the first question, the state of user can be grasped quickly.

In the present disclosure, when the user responding operation in response to the preceding output is received, the notice of the user responding operation reception is transmitted to the server device. Therefore, the monitoring side of the user can confirm quickly that the user is alive.

In the present disclosure, after passing of the reference time period from outputting of the preceding output, if the user responding operation is not received, the communication terminal device transmits the notice of no user responding operation to the server device. Therefore, the monitoring side can grasp at an earlier stage that the user seems to be unwell.

In the present disclosure, when the notice of user responding operation reception is not received, the preceding output is outputted again. Therefore, it is possible to provide opportunities repeatedly to confirm whether or not the user is alive, and the accuracy of the user state confirmation can be improved.

Moreover, in the present disclosure, the server device stores the server reference time period, and determines whether or not the notice of the user operation reception is received. Therefore, the processing load on the communication terminal device, for determining whether or not the notice of the user operation reception is received, can be reduced.

Further, in the present disclosure, when the re-outputs of the preceding output are repeated for a predetermined number of times, if the notice of the user responding operation reception is not received, the communication terminal device transmits the notice of the user abnormal state. Therefore, the monitoring side can grasp the high probability of the user abnormal state at an earlier stage.

Furthermore, in the present disclosure, the server device performs processing for the repeated re-outputs of the preceding output for a number of times. Therefore, the processing load on the communication terminal device can be reduced, and the server device can grasp the occurrence of user abnormal state even in the environment incapable of transmitting the notice from the communication terminal device to the server device.

In the present disclosure, the server transmits the data of the preceding output to the communication terminal device. Therefore, the server device can change the contents of the preceding output, and the boredom of the user about the contents of the preceding output can be prevented.

In the present disclosure, the communication terminal device stores the data of the preceding output. Therefore, the preceding output can be outputted quickly without communicating with the server device.

In the present disclosure, the server device transmits, the data of the part of element constituting the preceding output to the communication terminal device, and the communication terminal device reads the data of the other part of element stored by itself, so that the preceding output is outputted based on the data of the part and the data of the other part. Therefore, various contents can be secured for the preceding output, and the attention of user can be drawn to the contents of the preceding output.

### BRIEF DESCRIPTION OF THE DRAWINGS

FIG. 1 is a schematic view of a local government watching service, to which a user state confirmation system of an embodiment of the present disclosure is applied.

FIG. 2 is a schematic view of the user state confirmation system of the embodiment.

FIG. 3 is a block diagram briefly showing an internal structure of a television device.

FIG. 4 is a schematic view of a remote controller.

FIG. 5(a) is a schematic view of a first question page, and FIG. 5(b) is a schematic view of an answer page.

FIG. 6(a) is a schematic view of a local government home page, and FIG. 6(b) is a schematic view of a living information page.

FIG. 7(a) is a schematic view of a neighborhood community information page, and FIG. 7(b) is a schematic view of a second question page.

FIG. 8 is a block diagram briefly showing an internal structure of a server device.

FIG. 9 is a table showing an example of a user DB (data base) for a local government.

FIG. 10 is a table showing an example of an answer DB of one day, for a local government.

FIG. 11(a) is a table showing a second question DB, and FIG. 11(b) is a table showing a registered local government DB.

FIG. 12 is a schematic view of a home page.

FIG. 13(a) is a schematic view of a state list page, and FIG. 13(b) is a schematic view of a detail page.

FIG. 14 is a first flowchart showing processing of a user state confirmation method.

FIG. 15 is a second flowchart showing processing of the user state confirmation method.

FIG. 16 is a third flowchart showing processing of the user state confirmation method.

FIG. 17 is a fourth flowchart showing processing of the user state confirmation method.

FIG. 18 is a schematic view of a first question page of a modification.

FIG. 19(a) is a schematic view of a state list page of the modification, and FIG. 19(b) is a schematic view of a detail page of the modification.

FIG. 20 is a schematic view of contents of an email.

FIG. 21(a) is a schematic view showing a state in which a pop-up screen appears on a display, and FIG. 21(b) is a schematic view of the pop-up screen.

FIG. 22 is a fifth flowchart showing processing of a user state confirmation method according to a second embodiment of the present disclosure.

FIG. 23 is a sixth flowchart showing processing of a user state confirmation method according to a modification of the second embodiment of the present disclosure.

FIG. 24 is a seventh flowchart showing processing of a user state confirmation method according to another modification of the second embodiment.

FIG. 25 is an eighth flowchart showing processing of a user state confirmation method according to still another modification of the second embodiment of the present disclosure.

FIG. 26 is a ninth flowchart showing processing of a user state confirmation method according to still another modification of the second embodiment of the present disclosure.

FIG. 27 is a tenth flowchart showing processing of a method of confirming a state of a user according to still another modification of the second embodiment of the present disclosure.

FIG. 28 is an eleventh flowchart briefly showing substantial processing of a method of confirming a state of a user according to a third embodiment of the present disclosure.

FIG. 29 is a twelfth flowchart briefly showing substantial processing of a method of confirming a state of a user according to a fourth embodiment of the present disclosure.

### MODES FOR CARRYING OUT THE INVENTION

### First Embodiment

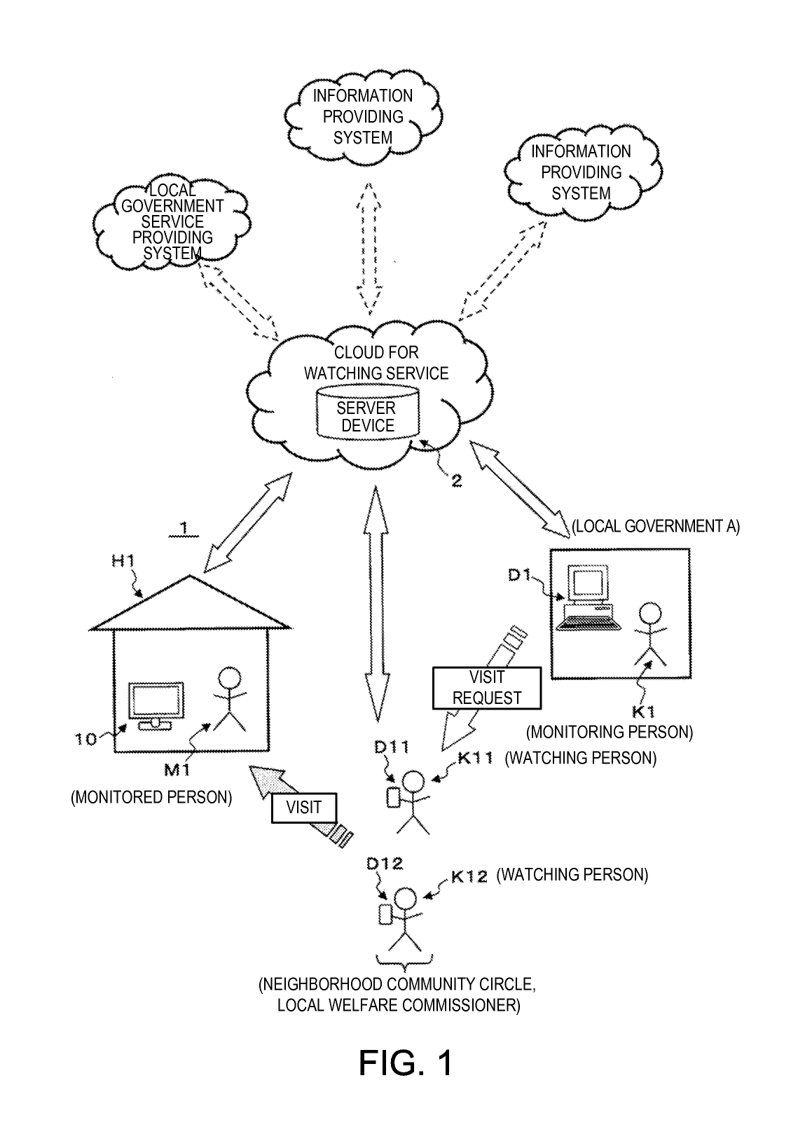

FIG. 1 is a view schematically showing a user state confirmation system 1 according to a first embodiment of the present disclosure, applied to a local government watching service. With the watching service shown in FIG. 1, a state of person (monitored person M1) living in a local house H1 belonging to a local government, is remotely monitored by a monitoring person K1 of a local government A by using the user state confirmation system 1. If it is found, as a result of monitoring, that the monitored person M1 needs to be visited actually, the monitoring person K1 of the local government A will notify (for example, send a visit request to) watching persons K11, K12 belonging to a neighborhood community circle or a local welfare commission, and upon receiving such a notice, the watching persons K11, K12 actually visit the monitored person M1 in order to confirm the state.

A server device 2, constituting a cloud system for the watching service, assumes a central role in the watching service of FIG. 1. The server device 2 is linked, via a communication network, to a local government service provider system, and a plurality of other information provided systems (weather forecasting provider system, city information provider system, shopping mall information provider system, etc.), so that various types of information from a server of each system can be obtained and provided to the monitored person M1.

The server device 2 is connected, via a communication network (such as internet) to be communicative with a television device 10 installed in the house H1 of the monitored person M1, so that various types of information and data can be communicated interactively. Furthermore, the server device 2 operates an internet website for the monitoring person of the local government, and through this website, the monitoring person K1 of each of local governments registered in the watching service can confirm the state of the monitored person M1 to be monitored remotely on proper occasions, by using a communication terminal D1, and besides, the monitoring person K1 can transmit notices to portable communication terminals D11, D12 operated by the watching persons K11, K12.

As the communication terminal D1 of the monitoring person K1, a personal computer with a communication function, and various portable communication terminals (e.g., a laptop PC with a communication function, a smartphone, a PDA with a communication function, a portable phone, etc.) can be utilized. Furthermore, as the portable communication terminals such as D11 used by the watching persons K11, K12, laptop computers with communication functions, smartphones, PDAs with communication functions, portable phones, etc., can be utilized. As the communication function of the communication terminal D1, other than wire communication, wireless communication in various standards can be utilized. Furthermore, as the communication function of the portable communication terminals such as D11 used by the watching persons K11, K12, wireless communication in various standards can be used suitably.

Moreover, in FIG. 1, for the purpose of concise explanation, only one person appears as the monitored person M1, but needless to say, the watching service of the present disclosure can cope with the use by two or more monitored persons. Similarly, in FIG. 1, although only one person appears as the monitoring person K1 of the local government A, the watching service of the present disclosure can cope with operation by two or more monitoring persons. In addition, in FIG. 1, although only one local government A appears, the watching service of the present disclosure can cope with operation by two or more local governments (local government B, local government C, . . . etc., other than the local government A), and the system can be constructed separately for each local government, including the monitored persons, the monitoring persons and the watching persons, respectively. The user state confirmation system 1, constituting the major component of the watching service shown in FIG. 1, will be described in detail hereunder.

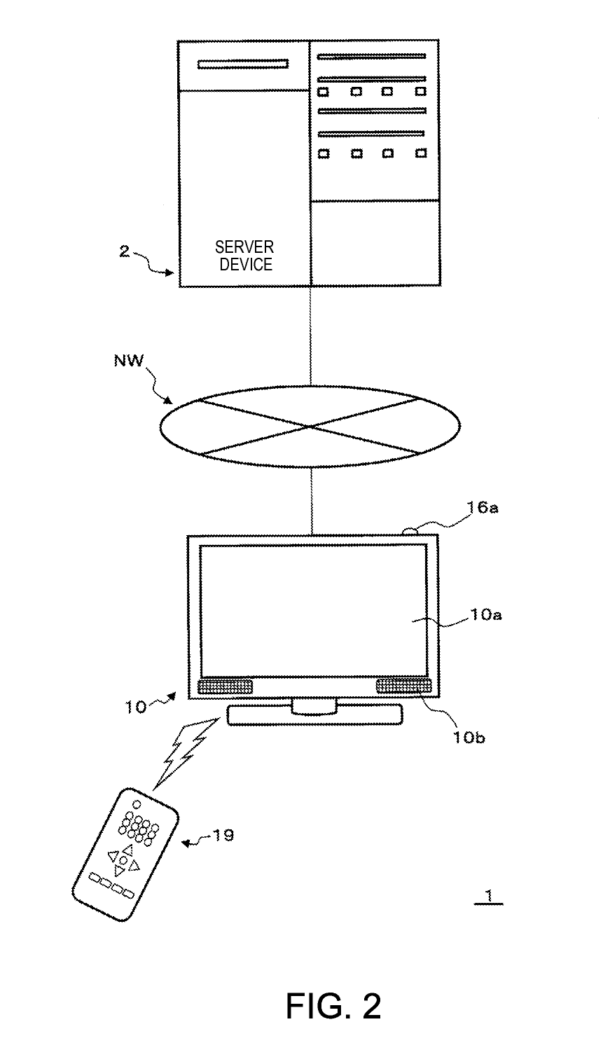

FIG. 2 shows the user state confirmation system 1 according to the embodiment of the present disclosure. In the user state confirmation system 1, the server device 2 is connected to the television device 10 installed in the house H1, via a network NW. The television device 10 is provided, in addition to ordinary television functions, with a communication function, thereby the television device 10 serves as a communication terminal device. The television device 10 includes a display screen 10a and speakers 10b on the front part of a housing, and a power switch 16a is provided on the housing, which receives various operation commands by the user (for example, the monitored person M1) by a remote controller 19.

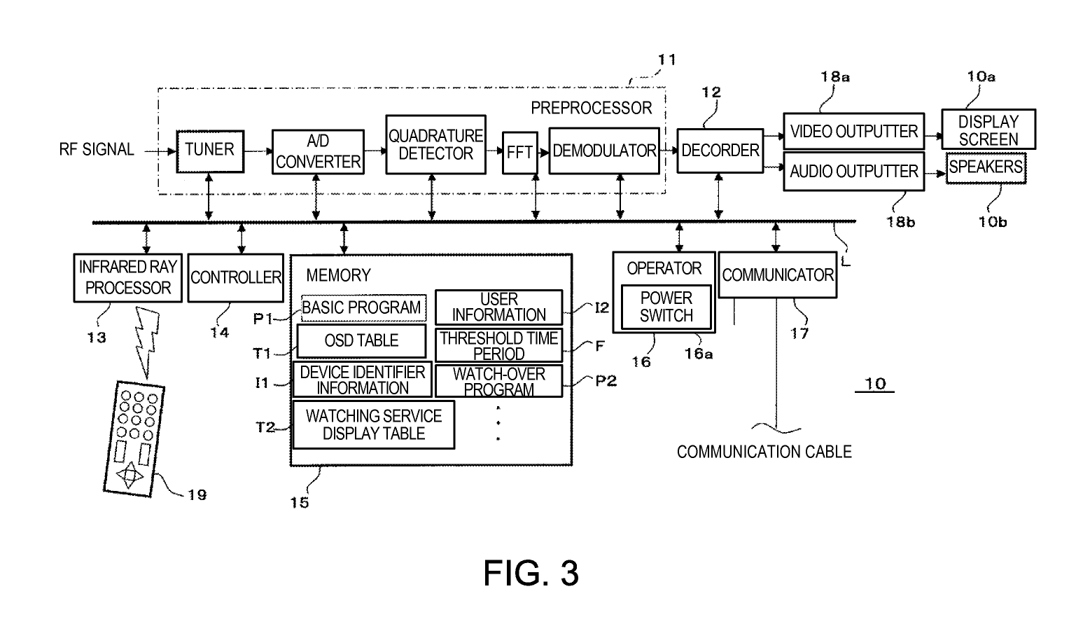

FIG. 3 briefly shows an internal structure of the television device 10. The television device 10 includes a preprocessor 11, a decoder 12, an infrared ray processor 13, a controller 14, a memory 15, an operator 16, a communicator 17, a video outputter 18a, and an audio outputter 18b, etc., connected by inner connection cables L. Moreover, the inner parts such as the preprocessor 11 transmit and receive the signal to and from the controller 14 via the inner connection cables L. The inner parts such as the preprocessor 11 transmit the signal indicating the current processing state to the controller 14, and meanwhile, the controller 14 grasps the current processing state from the processing states, etc., transmitted from the inner parts such as the preprocessor 11, and transmits the control signal to the inner parts such as the preprocessor 11 for controlling the next processing corresponding to the grasped state. The each part of the television device 10 will be explained hereunder.

The preprocessor 11 includes a tuner, an A/D converter, a quadrature detector, an FFT module, and a demodulator, into which an RF signal (digital broadcast signal) gained by an antenna is inputted. The input signal is subject to predetermined processing to demodulate transport stream (TS), and is transmitted to the decoder 12 for the next processing. The decoder 12 performs decoding on the transport stream demodulated in the preprocessor 11, so that the video, audio and other data are separated. The separated video stream is subject to the video decoding configured to output to the video outputter 18a, and the separated audio stream is subject to the audio decoding configured to output to the audio outputter 18b.

The video outputter 18a applies necessary processing to a predetermined video output so as to generate a video signal, and the generated video signal is outputted to the display screen 10a, whereby the display screen 10a displays broadcast video images of a broadcast program, etc. Moreover, the audio outputter 18b applies necessary predetermined processing such as amplification to the audio output so as to generate an audio signal, and the generated audio signal is outputted to the speakers 10b, whereby the speakers 10b output various sounds.

In the meantime, as the part related to an interface system with the user, the infrared ray processor 13 performs communication processing (transmission/receiving of signal/data) compliant with a known infrared ray (IR) standard (for example, various standards of IrDA system), and basically, receives an infrared ray including an operation signal emitted from the remote controller 19 which receives the operation by the user, and transmits such a signal to the controller 14. The controller 14 assumes a central role while the television device 10 performs the incorporated various functions, and based on various processing contents defined in a basic program P1 and a watching program P2 stored in the memory 15, performs various processing items (communication control processing, OSD processing, information output processing, etc.).

Moreover, the television device 10 is provided with the memory 15 as a memory medium. The memory 15 stores data related to the basic functions of the television device 10, such as the basic program P1, an OSD table T1, a device identifier information I1, etc., and also stores data related to the watching service of the present disclosure, such as a watching service display table T2, user information I2, a threshold time period F, the watching program P2, etc.

The basic program P1 corresponds to a firmware and a system program of the television device 10, defining various processing items of the controller 14 necessary for the television device 10 to function as the television device (various functions to watch television programs, communication function, etc.). The OSD table T1 stores a plurality of indication parts data for performing OSD appropriately, such as images and texts used for various menu items and alerts. The device identifier information I1 indicates an identifier code of the television device 10, which can be used as the identifier information between other communication devices during the communication.

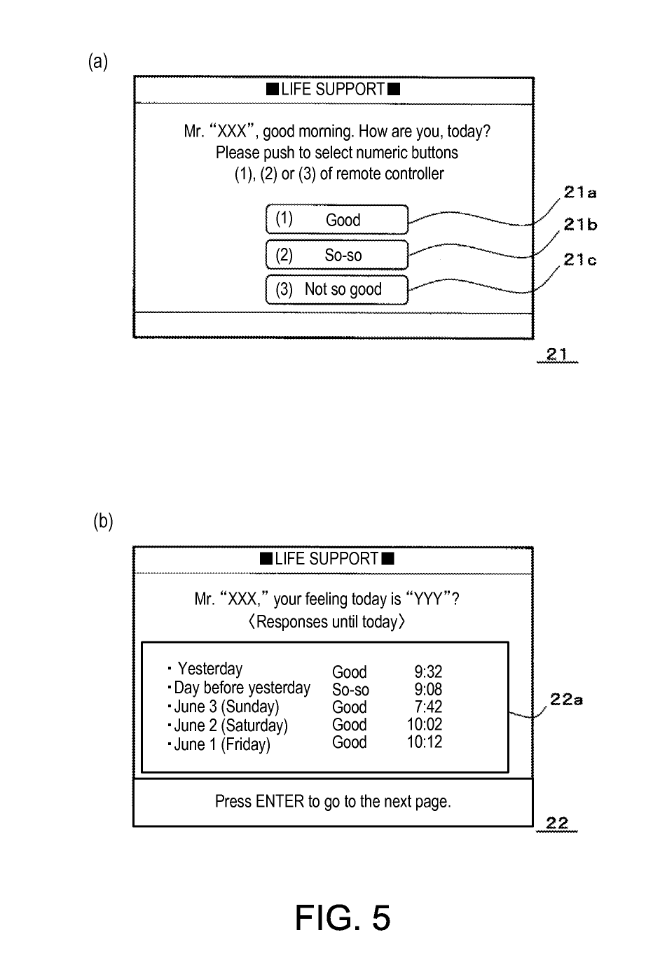

Moreover, the watching service display table T2 stores various indication parts data for indicating images and texts of the watching service pages on the display screen 10a of the television device 10, and in the present embodiment, includes the indication parts data according to each of pages as shown in FIGS. 5 to 7.

For example, in a first question page 21 as shown in FIG. 5(a), the indication parts data includes a text of a question (a first question) and first to third buttons 21a-21c as a plurality of selective answers to that question. Also, in the part of “XXX” in the text, a name (or nickname, etc.) of a user incorporated in the user information I2 (which will be explained afterwards) is read and pasted from the memory 15. Moreover, the greetings “Good morning” pasted on the text varies according to the period of time, and the watching service display table T2 includes other texts of the greetings such as “Good afternoon” and “Good evening.”

The center part of an answer page 22 shown in FIG. 5(b) indicates pasted answer information 22a transmitted from the server device 2, and the watching service display table T2 includes parts data according to a text of “LIFE SUPPORT” positioned in an uppermost column, a text placed above the answer information 22a, and a bar-shaped text (“Press ENTER to go to the next page”) in a lowermost column (similar in the first question page 21). Also, the part “XXX” in the text above the answer information 22a is similar to that of FIG. 5(a) described above, and the contents of answer selected in FIG. 5(a) are pasted on “YYY.”

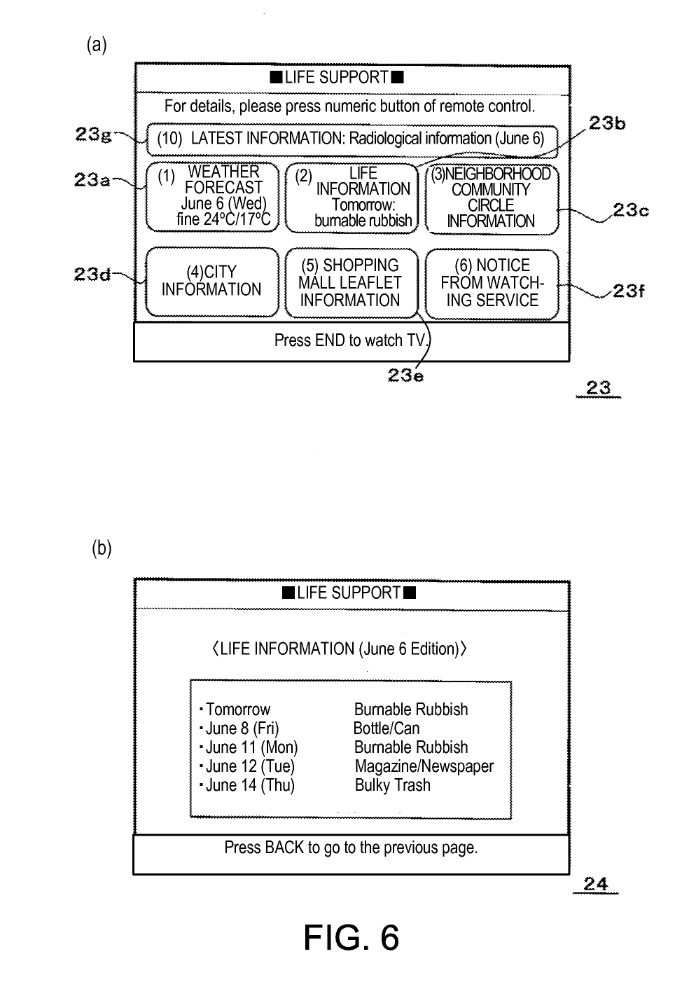

A local government home page 23 as shown in FIG. 6(a) basically indicates a website home page operated by a local government service provider system shown in FIG. 1, and the website home page is disposed in the part between the text of “LIFE SUPPORT” in the uppermost column and the bar-shaped text (“Press END to watch TV”) in the lowermost column.

Note that, a plurality of option box items 23a-23g is disposed in the home page of the local government service provider system, and the bar-shaped option box item 23g in the uppermost part is assigned to a numeric button “10” of the remote controller 19, with the link to a web page supplying latest information (for example, a website of radioactive hazard information). When the numeric button “10” is depressed, the above webpage is accessed and the indication contents transit to that webpage. Moreover, the first option box item 23a in the left-upper part is assigned to a numeric button “1” of the remote controller 19, with the link to a webpage providing a weather forecasting program.

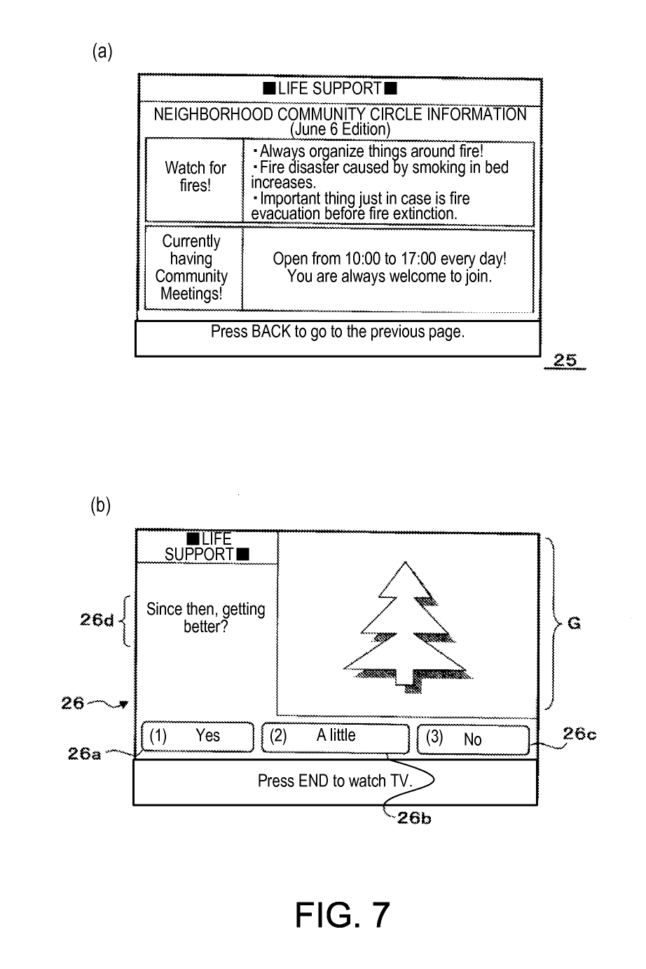

The second option box item 23b in the middle-upper part is assigned to a numeric button “2” of the remote controller 19, with the link to webpage providing living information of a neighborhood community circle. When the numeric button “2” is depressed, the indication transits to a living information page 24 (rubbish collection schedule) as shown in FIG. 6(b). The third option box item 23c in the right-upper part is assigned to a numeric button “3” of the remote controller 19, with the link to webpage providing information of the neighborhood community circle, When the numeric button “3” is depressed, the indication transits to a neighborhood community circle information page 25 as shown in FIG. 7(a).

In addition, the fourth option box item 23d in the left-lower part is assigned to a numeric button “4” of the remote controller 19, with the link to webpage providing city information. Moreover, the fifth option box item 23e in the middle-lower part is assigned to a numeric button “5” of the remote controller 19, with the link to webpage providing shopping mall information. Further, the sixth option box item 23f in the right-lower part is assigned to a numeric button “6” of the remote controller 19, with the link to webpage providing company information operating the server device 2.

FIG. 7(b) shows a second question page 26. The second question page 26 is in an L-shaped box surrounding broadcast video images G of a television program displayed on the display screen 10a. A text 26d indicating a question (a second question), and first to third buttons 26a-26c indicating the selective answers to the question, are disposed in the second question page. The server device 2 transmits information of the contents of the text 26d and the texts of these first to third buttons 26a-26c, and the transmitted information is disposed in a form the second question page 26 as shown in FIG. 7(b).

Moreover, the user information I2 in the memory 15 as shown in FIG. 3 stores information of a user registered in the watching service (the monitored person M1), including the name/nickname of a user, the user identification number (user ID), etc. When the user inputs mandatory items (name, nickname, address, age, gender, contact details of monitoring person, password, etc.) according to a predetermined format for user registration of the watching service, these items are transmitted to the server device 2, and after completion of a user registration, information including some of the mandatory items inputted by the user are transmitted, as the user information 12, from the server device 2 to the television device 10. The transmitted user information I2 is stored in the memory 15.

In addition, the threshold time period F stored in the memory 15 is used in processing among a plurality of processing items defined by the watching program P2 (which will be described afterwards). In the present embodiment, the value is set to 3 minutes as the default, but it is adjustable to a desired value between 10 seconds and 10 minutes, by using a setting menu which is not illustrated.

More in addition, the watching program P2 stored in the memory 15 is an application program defining the processing of the television device 10 for performing the watching service (the service related to the user state confirmation system 1) of the present disclosure, and is installed appropriately as the application program in the memory 15 of the television device 10 (besides, during manufacturing of the television device 10, it is also possible to preinstall the program in the memory 15, of course). The watching program P2 defines the contents of processing performed by the controller 14 for the watching service, of which various contents are explained below.

As a first example of processing defined by the watching program P2, a power-on operation is explained. Upon the power-on operation by the user, a power-off state transits to a power-on state, and if that power-on operation is the first operation of the day, the watching program P2 defines processing to set a flag indicating that the power is on (power-on flag) in the memory 15, and also defines processing to transmit first power-on information, indicating that this is the first power-on state of the day, to the server device 2, together with the device identifier information I1 and the user ID, by using the communicator 17. The controller 14 can determine if this is the second (or later) power-on operation of the day, by checking whether or not the power-on flag is set in the memory 15. If this is the second (or later) power-on operation of the day, the watching program P2 defines processing to transmit second/later power-on information, indicating that this is the second (or later) power-on operation of the day, to the server device 2, together with the device identifier information I1 and the user ID, by using the communicator 17.

Note that, the controller 14 of the television device 10 constantly detects the current date and time based on the information indicating date and time information included in the receiving broadcast signal, and when the change of the date is detected based on the detection of the current date and time, the watching program P2 also defines, if the power-on flag has been set in the memory 15, to reset the power-on flag to change the flag to a non-set status.

Moreover, upon the power-on operation, after transmitting the first power-on information, in order to display the first question page 21 of FIG. 5(a) on the display screen 10a, the watching program P2 defines processing to read the indication parts data of the first question page 21 from the watching service display table T2 stored in the memory 15. Here, based on the read indication parts data, after performing indication output of the first question page 21 to the display screen 10a, the watching program P2 defines processing to count (measure) the time until receiving the answer by selection from the first to third buttons 21a-21c included in the first question page 21. In addition, the watching program P2 also defines processing to compare whether or not the measured time exceeds the threshold time period F stored in the memory 15.

As the result of comparison, if the measured time does not exceed the threshold time period F, and within that threshold time period F, if any of the buttons from the first to third buttons 21a-21c is selected and the answer to the first question 21 is received, the watching program P2 defines processing to transmit first response information (first answer), indicating the answer of the selected button, to the server device 2 by using the communicator 17. In addition, if any of the first to third buttons 21a-21c is not selected (if the answer to the first question 21 is not received), and as the result of comparison, if the measured time exceeds the threshold time period F, the watching program P2 defines processing to transmit the first response information to the server device 2, indicating that there is no response to the first question 21.

The watching program P2 also defines other various processing contents, for example, processing in response to the bar-shaped text (“Press ENTER to go to the next page”) in the lowermost column of FIG. 5(b) to FIG. 7(a). Moreover, in the second question page 26 of FIG. 7(b), upon operation of a question request button 19f of the remote controller 19, the watching program P2 defines processing to transmit second question request information to the server device 2, together with the device identifier information I1 and the user ID. When the data indicating the second question (text data, etc.) is transmitted from the server device 2, the watching program P2 defines processing to generate the second question page 26 as shown in FIG. 7(b) by using the transmitted data, and to display the output data.

Note that, in the displayed second question page 26, the watching program P2 defines similar processing as that of the first question page 21 of FIG. 5(a) described above. If the user selects any of the first to third buttons 26a-26c within the threshold time period F, the watching program P2 defines processing to transmit second response information indicating the selected answer to the server device 2 by using the communicator 17, and if the threshold time period F passes without any selection, the second response information, indicating that there is no response to the second question, is transmitted to the server device 2.

In addition, upon the power-off operation by the user, the watching program P2 defines processing to transmit power-off information indicating that the power is off, to the server device 2 together with the device identifier information I1 and the user ID, by using the communicator 17.

The explanation of internal structure of the television device 10 is continued by referring back to FIG. 3. The operator 16 is provided in the housing of the television device 10 as a user interface, including a power switch 16a to turn on/off of main power, and further including a volume control button, a channel selection button, an input selection button, etc. Moreover, the communicator 17 corresponds to a communication function, and performs communication processing based on a known communication standard (for example, LAN standard such as IEEE, standard under DNLA, etc.) according to the control by the controller 14, having a connectivity with communication cables such as LAN cable. The communicator 17 has two envisaged structure, namely, the incorporation in the television device 10, and the auxiliary attachment to an auxiliary connector of the television device 10 (for example, HDMI (registered trademark) connecting terminal, USB connecting terminal, IEEE 1394 connecting terminal, etc.). Moreover, in the case of auxiliary attachment, it is also possible that, by storing the watching program P2, etc., as described above, in an auxiliary communication terminal device corresponding to the communicator 17, a CPU of that communication device performs various processing items for the watching service. Thus, even in the case of auxiliary attachment of the communicator 17, according to the present disclosure, the television device 10 performs its function integrated with the auxiliary communicator 17.

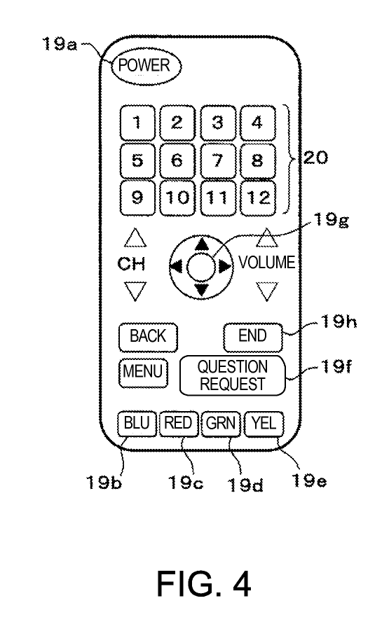

FIG. 4 shows the remote controller 19 emitting infrared ray to the infrared ray processor 13 as described above. The remote controller 19 includes a power switch 19a at the top part for turning on/off of the television device 10, and also includes, numeric buttons 20 comprising twelve buttons, a cross key, an enter button 19g, a volume control key, a channel selection key, the question request button 19f, a back button, an end button 19h, a menu button, and in addition, four color buttons (a blue button 19b, a red button 19c, a green button 19d and a yellow button 19e). When the operation of the user is received by any of these buttons and switches, the infrared ray indicating the contents of received operation is emitted from the remote controller 19. Note that, when either the power switch 16a of the operator 16 or the power switch 19a of the remove controller 19, as described above respectively, is operated by the user, the power-on operation or the power-off operation is performed.

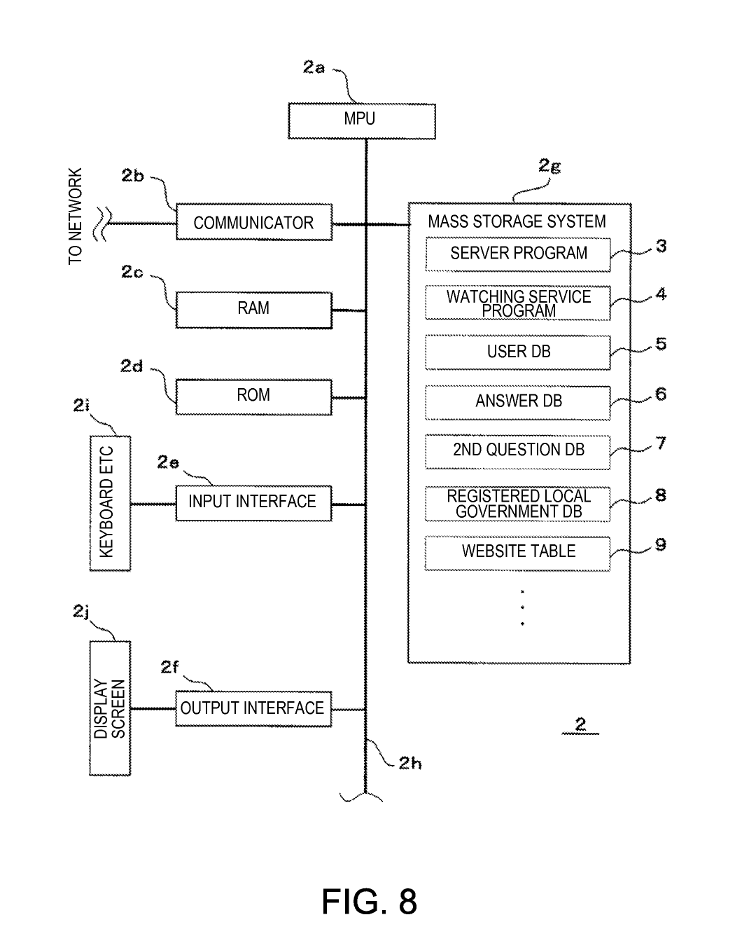

FIG. 8 briefly shows an internal structure of the server device 2 of the watching service (user state confirmation system 1). A common server computer is applied to the server device 2 of the present embodiment, in which an MPU 2a performs the total control and various processing items, and various devices, etc., are connected thereto by inner connection cables 2h. The various devices include a communicator 2b, a RAM 2c, a ROM 2d, an input interface 2e, an output interface 2f, a mass storage system (HDD system) 2g, etc.

The communicator 2b, as a communication device, corresponds to a connecting module to the network NW, compliant with a predetermined communication standard (for example, an LAN module). The communicator 2b is connected to the network NW via a predetermined communication device (for example, a router—not shown in the drawing), enabling the communication among the television device 10 of the user (monitored person), the communication terminal D1 of the local government, and the portable communication terminals D11, D12 used by the watching person K11, K12 of the neighborhood communication circle or the local welfare commission.

The RAM 2c temporarily stores the contents, files, etc., used for the processing by the MPU 2a, and the ROM 2d stores programs, etc., defining the basic contents of processing of the MPU 2a. A keyboard 21, a mouse 2a, etc., for receiving the operation and command by an operator of the cloud system for the local government watching service, are connected to the input interface 2e, and the input interface 2e transmits the operation and command by the operator, to the MPU 2a. A display screen 2j (image output device) is connected to the output interface 2f, and the output interface 2f outputs the contents of processing by the MPU 2a, to the display screen 2j, so that the operator can confirm the contents of current processing, etc.

The mass storage system 2g (corresponding to a memory device) stores various databases (DBs) and programs including necessary data for providing the watching service, and in particular, includes a server program 3, a watching service program 4, a user DB 5, an answer DB 6, a second question DB 7, a registered local government DB 8, a website table 9, etc.

The server program 3 defines various processing items of the server operation system, and with processing by the MPU 2a based on the defined contents, the server device 2 performs basic functions as the server computer. The watching service program 4 will be described afterwards, and the user DB 5 is explained first, as below.

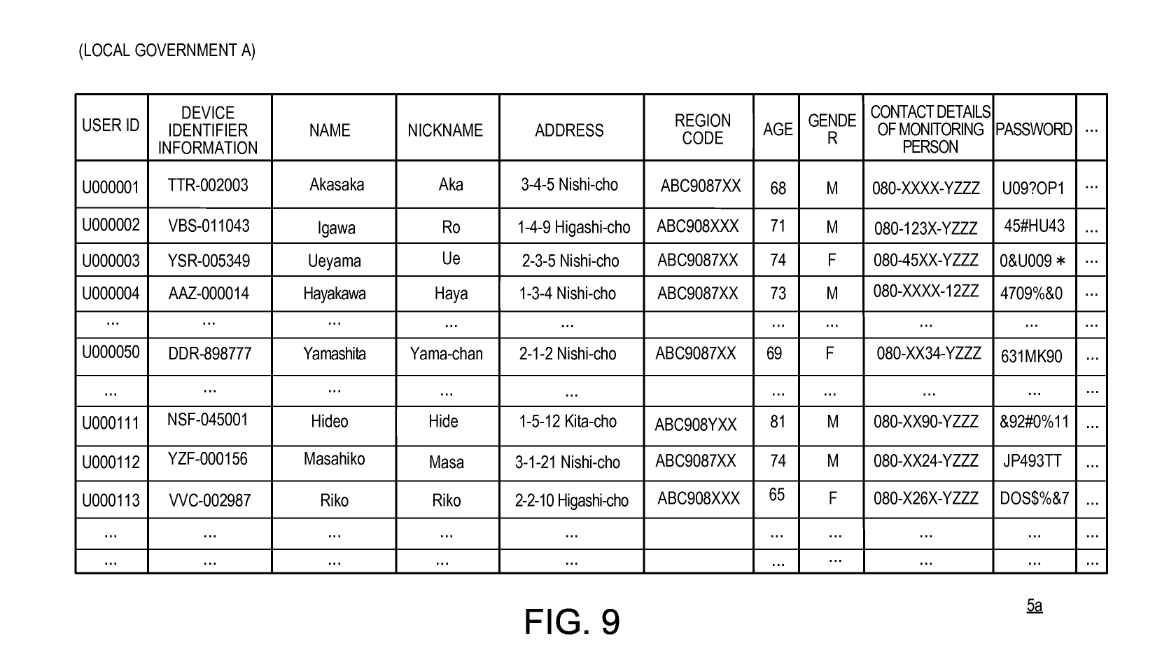

FIG. 9 briefly shows the contents of a local government A's user DB 5a, for a registered user belonging to the local government A in the user DB 5. The user DB 5 collectively includes the user information of each of local governments using the watching service (namely, the user DB 5 collectively includes the local government A's user DB, a local government B's user DB, a local government C's user DB . . . ), and FIG. 9 shows the local government A's user DB 5a. The local government A's user DB 5a stores, in a “user ID” for identifying the registered user, “device identifier information” of the television device 10 used by the user, and user's “name,” “nickname,” “address,” “region code,” “age,” “gender,” “contact details of monitoring person,” “password,” etc. The user information is transmitted by the user at the time of watching service registration, and the necessary items therein are transmitted, as the user information I2, from the server device 2 to the television device 10, and are stored as the user information I2 of the memory device 15 of the television device 10.

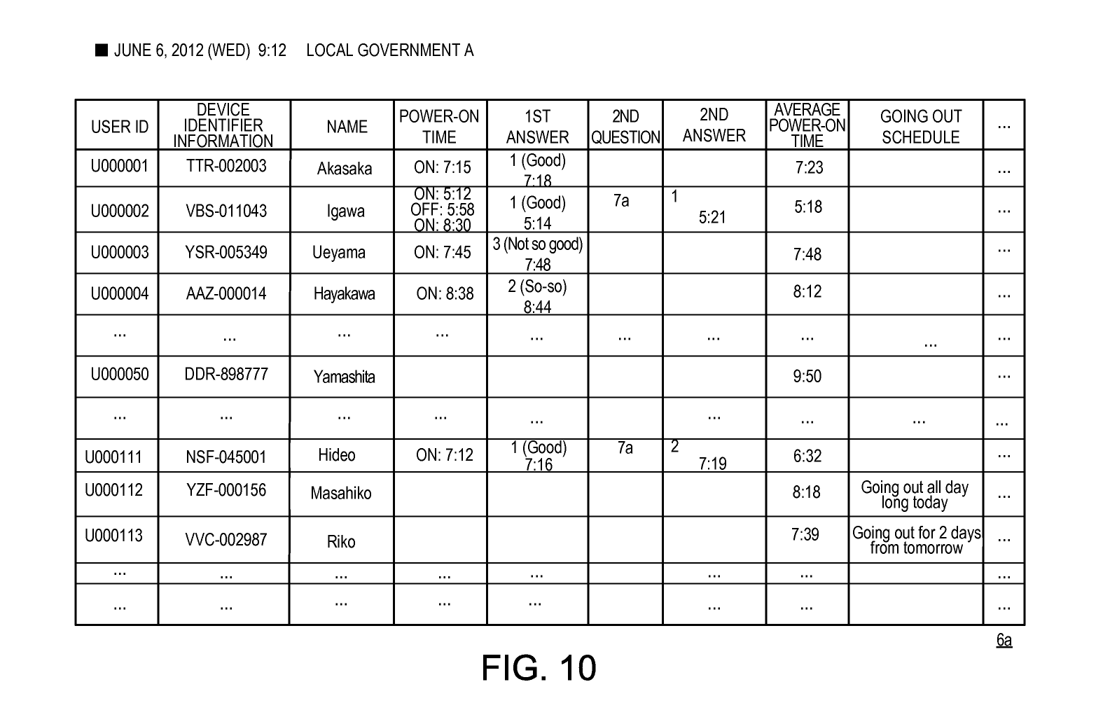

FIG. 10 briefly shows the local government A's answer DB 6a indicating the answering state of registered users belonging to the local government A in the answer DB 6. The answer DB 6 is also a collective DB indicating the answers of users of the day, in each of the local governments. Therefore, the answer DB 6 sequentially accumulates each day's information, and for example, the answer DB 6 collectively stores, the local government A's answer DB for the period from Jan. 1, 2012 to Jun. 6, 2012, the local government B's answer DB for the period from Jan. 1, 2012 to Jun. 6, 2012, the local government C's answer DB for the period from Jan. 1, 2012 to Jun. 6, 2012 . . . .

FIG. 10 shows the local government A's answer DB 6a on Jun. 6, 2012, in the answer DB 6. In particular, the local government A's answer DB 6a stores corresponding information in box items “user ID,” “device identifier information,” “name” of a user, “power-on time (including two or more power-on times, if there are two or more power-on times),” “first answer,” “second question,” “second answer,” etc., and also stores the average time of the first power-on time in the box items of “power-on average time.”

Among the box items of the local government A's answer DB 6a as described above, the information transmitted from the television 10 is stored in the box items of “power-on time (including two or more power-on times, if there are two or more power-on times),” “first answer” and “second answer,” together with date and time of the reception, and if such a box is empty, it indicates that the answer has not been transmitted at that time. The box item of “second question” indicate the type of second question transmitted by the server device 2, and when the server device 2 transmits the second question, the type of that second question is stored. Moreover, the average time of the first power-on time stored in the box item of “power-on average time” is obtained by calculating the average of the first power-on time, stored so far, by the MPU 2a of the server device 2.

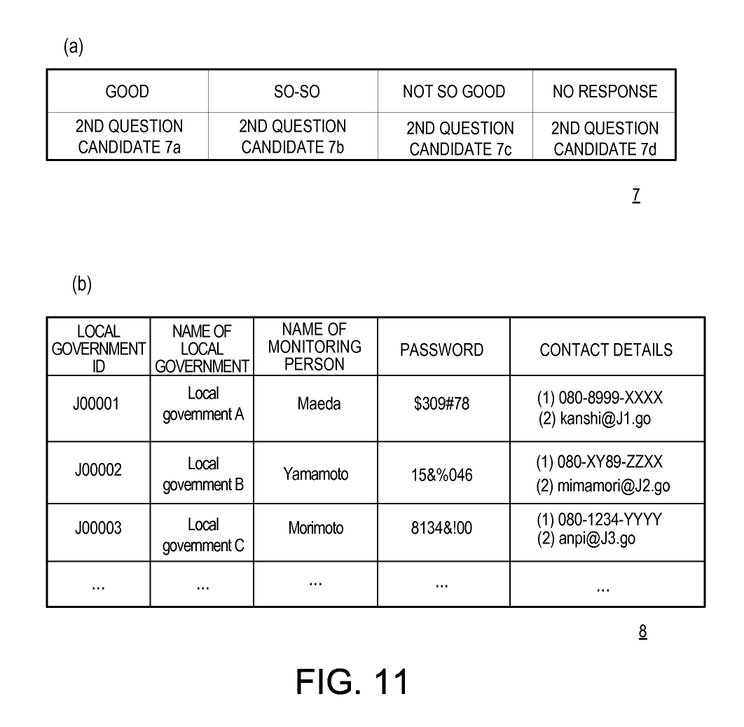

FIG. 11(a) briefly shows the second question DB 7. In the second question DB 7, for each of the responses of the user to the first question (the first response information), four second questions (corresponding to second question candidates) are stored. In particular, for each of the box items “Good,” “So-so” and “Not so good” as the answers to the first question page 21 shown in FIG. 5(a), and also for the box item indicating that the threshold time period is over (“time over”), a second question candidate 7a, a second question candidate 7b, a second question candidate 7c and a second question candidate 7d are stored, respectively. Note that, each of the second question candidates 7a to 7d has a different content of question according to the response of the user to the first question.

For example, the second question candidate 7a is “Since then, still in good health?” (and the answers include selections of “Good,” “So-so” and “Unwell”), the second question candidate 7b is “Still then, any change in health?” (and the answers include selections of “No change,” “Better” and “Worse”), the second question candidate 7c is “Since then, getting better?” (and the answers include selections of “Yes,” “A little” and “No”), and the second question candidate 7d is “How's your health today?” (and the answers include selections of “Good,” “So-so” and “Not so good”).

FIG. 11(b) briefly shows the registered local government DB 8. The registered local government DB 8 stores information of a plurality of local governments A, B, C, etc., registered in the watching service, and stores various types of information submitted by the local government at the time of registration in the watching service. The items of information stored in the registered local government DB 8 include “local government ID,” “name of local government,” “name of monitoring person,” “PW (password),” “contact details,” etc. Note that, the item “local government ID” identifies information issued by an operation body of the watching service (the server device 2) when the local government is registered in the watching service. Moreover, the item “name of monitoring person” allows the accommodation of two or more persons. Note that, the item “PW (password)” is required when receiving the watching service, and this item stores the password requested by the local government at the time of registration in the watching service. Furthermore, the item “contact details” stores the telephone number, email address, etc., of the monitoring person of the local government (it is also possible to store two or more contact details).

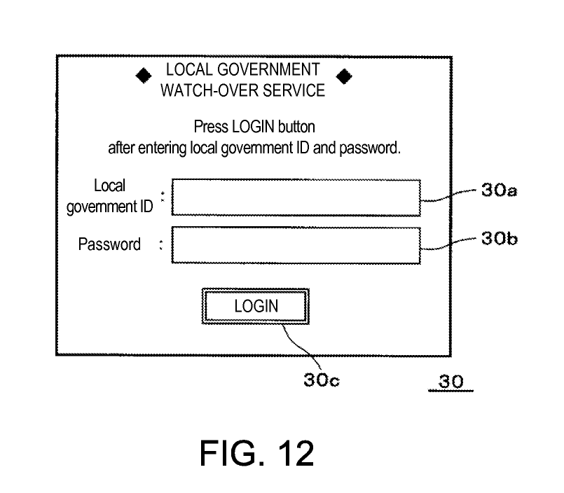

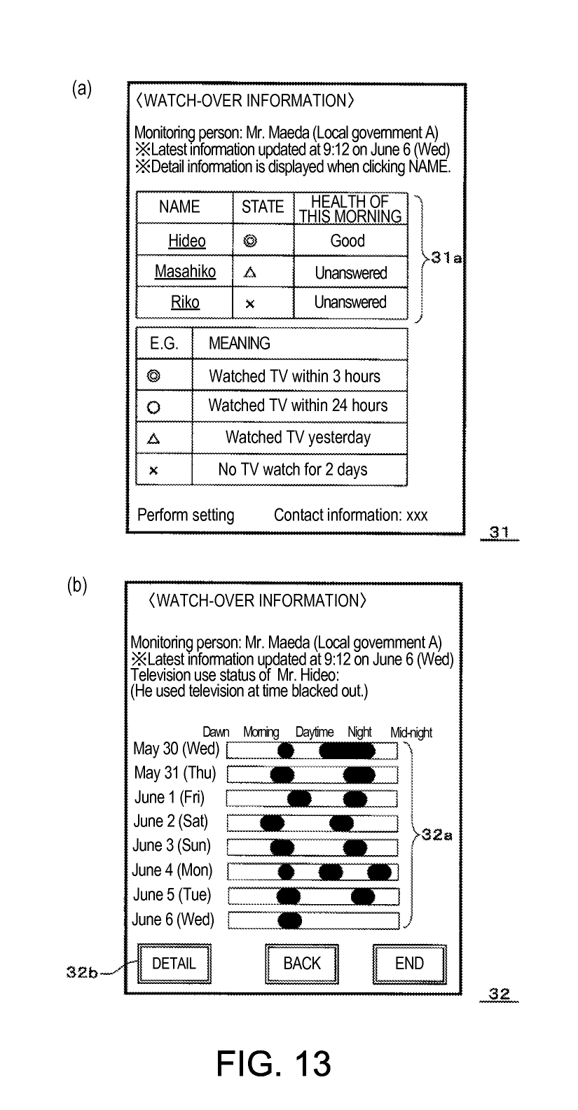

Moreover, the website table 9 stored in the mass storage system 2g stores page data (data based on HTML, XML, etc.) constituting web pages shown in FIGS. 12 and 13 as examples. For example, when an URL of website provided by the server device 2 is accessed from the communication terminal D1 of the monitoring person K1 of the local government A, the server device 2 reads page data of webpage (home page 30) as shown in FIG. 12 from the mass storage system 2g, and transmits the data to the accessing communication terminal D1. Thereafter, in accordance with the contents of operation transmitted from the communication terminal D1, the server device 2 reads appropriate page data according to each of web pages of FIGS. 13(a) and 13(b) from the mass storage system 2g, and transmits the data to the communication terminal D1. Note that, the website table 9 also stores various page data other than those of the webpage shown in FIGS. 12 and 13.

The home page 30 as shown in FIG. 12 is the website home page provided for the monitoring person of the local government of the watching service, disposing a local government ID input box item 30a, a PW (password) input box item 30b and a login button 30c.

Moreover, a state list page 31 shown in FIG. 13(a) includes a list 31a, disposing the current state of the monitored person belonging to the local government which logged in from the home page 30. The list 31a is prepared by the MPU 2a of the server device 2, by using, in the answer DB 6 as described above, information included in the latest answer DB for the logged-in local government. The respective names included in the list 31a can be selected.

FIG. 13(b) shows a detail page 32 indicating details of the monitored person selected from the list 31a of the state list page 31. The detail page 32 indicates the output display image transited from the state list page 31, in which, each power-on time of the monitored person selected in the state list page 31 for several days (for example, one week) is read from the answer DB 6 as described above, and based on the read information, the MPU 2a of the server device 2 generates and disposes a horizontal bar graph 32a.

Next, the watching service program 4 of the server device 2 is explained. The watching service program 4 corresponds to a computer program for server computer, and defines various processing items performed by the MPU 2a in order to provide the watching service. The watching service program 4 of the present embodiment primarily defines two processing items. The first processing is to sequentially prepare and accumulate the answer DB 6 as described above, and the second processing is to provide the accumulated information to the monitoring person of the local government on the web page.

The first processing of the watching service program 4 defines processing, upon receiving the power-on information transmitted from the communication terminal device (for example, the television device 10) of the monitored person, to store that power-on information in the answer DB 6 as described above, together with date and time of the reception. At that time, by referring to the device identifier information I1 and the user ID associated with the power-on information, the power-on information is stored in the box item of “power-on time,” matching with a predetermined user ID in the answer DB 6.

The watching service program 4 defines processing to determine whether or not the received power-on information is the first power-on information or the second or later power-on information, and when receiving the first power-on information, thereafter, also defines processing to receive the first response information transmitted from the communication terminal device (for example, the television device 10), and to store the contents of the received first response information in the box item of “first answer” in the answer DB 6, together with date and time of the reception of the first response information. At that time, by referring to the device identifier I1 and the user ID associated with the first power-on information as described above, the first response information is stored in the answer DB 6 matching with the predetermined user ID.

Here, after storing the contents of the first response information, the watching service program 4 defines processing to read the information stored in the box items of “first answer” for the latest several days (for example, five days), matching with the received user ID, from the answer DB 6 as described above, and to transmit, as answer history information, to the accessing communication terminal device (for example, the television device 10). Note that, when receiving the second or later power-on information, the watching service program 4 does not define any particular processing, and waits for receiving of the power-off information.

Moreover, after transmitting the answer history information, or after receiving and storing the second or later power-on information, when the power-off information transmitted from the communication terminal device (for example, the television device 10) of the monitored person is received together with the device identifier information I1 and the user ID, the watching service program 4 defines processing, by referring to the device identifier information I1 and the user ID, and also by matching with the predetermined user ID in the answer DB 6, to store the power-off information in the box item of “power-off time” together with the received time of power-off information. With the definition of the above processing by the watching service program 4, in the box item of “power-on time” of the answer DB 6, the power-on date and time and the power-off date and time of the day are accumulated sequentially, and thereby, it is possible to confirm remotely, that the monitored person is healthy and able to watch the television device 10.

In the second question page 26 as shown in FIG. 7(b), upon receiving the second question request information transmitted from the communication terminal device (for example, the television device 10) of the monitored person together with the device identifier information I1 and the user information I2, in the answer DB 6, based on the contents stored in the box item of “first answer” matching with the user ID of the received user information I2 (the first response information), the watching service program 4 defines processing to select one question matching with the contents, from the second question candidates 7a to 7d stored in the second question DB 7 as shown in FIG. 11(a). Note that, the watching service program 4 also defines to store the types of selected second questions (second question candidates) in the box item of “second question” of the answer DB 6.

Here, the watching service program 4 defines processing to read the selected second question candidate from the second question DB 7, and to transmit the read second question candidate, as the second question, to the communication terminal device (for example, the television device 10) as the origin of transmission of the second question request information. Thereafter, upon receiving the second response information in response to the transmitted second question, together with device identifier information I1 and the user ID from the communication terminal device (for example, the television device 10), by matching with the predetermined user ID in the answer DB 6, the watching service program 4 defines processing to store the contents of the second response information in the box item of “second answer” of the answer DB 6 together with date and time of the reception. With the definition of processing of the watching service program 4 as described above, since the contents of the first answer (the first response information) and the contents of the second answer (the second response information) transmitted from the monitored person are sequentially accumulated in the answer DB 6 together with the date and time of answer (response), it is possible to assume and grasp the mental and health conditions of the monitored person remotely, by the information stored in each of the box items of “first answer” and “second answer.”

In the meantime, for the purpose of providing the information, accumulated in the answer DB 6 as described above, to the monitoring person of each of the local governments via the webpage, upon access to the URL of that web page, the second processing of the watching service program 4 defines processing to transmit the page data to the accessing person, according to the home page 30 as shown in FIG. 12.

Moreover, in response to the transmission of the page data as described above, upon receiving the local government ID and the password transmitted from the accessing person, the watching service program 4 defines processing to determine whether or not the local government ID and the password coinciding with the received local government ID and the password exist, in the registered local government DB 8 as shown in FIG. 11(b). If the received local government ID and the password do not coincide with those stored in the registered local government DB 8, the watching service program 4 defines processing to transmit the page data of webpage to the accessing person, indicating that the local government ID and the password should be reentered.

When the received local government ID and the password coincide with those stored in the registered local government DB 8, the watching service program 4 defines processing to specify a local government answer DB (the latest date and time) of the coinciding local government ID from the answer DB 6, and by referring to the current date and time, to specify the state from the box items of “Watched TV within 3 hours,” “Watched TV within 24 hours,” “Watched TV yesterday” and “No TV watch for two days,” according to the information included in the box item of “power-on time” of the specified local government DB.

Here, by associating with the contents of the specified state, and each information read from the box items of “name” and “first answer” in the local government answer DB, the watching service program 4 defines processing to transmit the output data to the accessing person. With this processing, for example, the state list page 31 as shown in FIG. 13(a) is displayed in the communication terminal D1 of the monitoring person K1 of the local government A.

In addition, when the user ID of the person (user information I2) selected from the list 31a of the state list page 31 as shown in FIG. 13(a) is transmitted from the accessing person, the watching service program 4 defines processing to read the information of power-on times of that user ID for the latest several days (for example, one week) from the box item of “power-on time” of the answer DB 6, to generate the image indicating that information as the horizontal bar graph, and to transmit the generated image data to the accessing person. With this processing, for example, the detail page 32 as shown in FIG. 13(b) is displayed in the communication terminal D1 of the monitoring person K1 of the local government A.

Note that, the watching service program 4 defines processing to display other web pages in the communication terminal D1 of the monitoring person K1. For example, when receiving the data that the accessing person selects a DETAIL button 32b of the detail page 32 from the accessing person, the watching service program 4 defines processing to read the information stored in the box items “first answer,” “second question” and “second answer” from the answer DB 6, and to transmit that information to the accessing person. Accordingly, the monitoring person K1 can confirm the information of the monitored person stored in the answer DB 6 from various points of view, and can utilize the information as the material for determining whether or not the monitored person must be visited, etc. The various web pages can be displayed, not only in the communication terminal D1 of the monitoring person K1 of the local government, but also in the portable communication terminals D11, D12, etc., operated by the neighborhood community circle or the local welfare commission, etc., as long as the local government ID and the password are valid, and needless to say, can also be displayed on the display 2j of the server device 2.

Note that, in the above explanation, the watching service program 4 includes the two types of processing as described above. However, it is also possible to define the above first processing and the second processing by separate programs, so as to use these separate programs. Moreover, in the above explanation, the single server device 2 performs various processing items. However, it is of course possible to constitute a server device system by linking two or more server devices, so as to perform distributed various processing items.

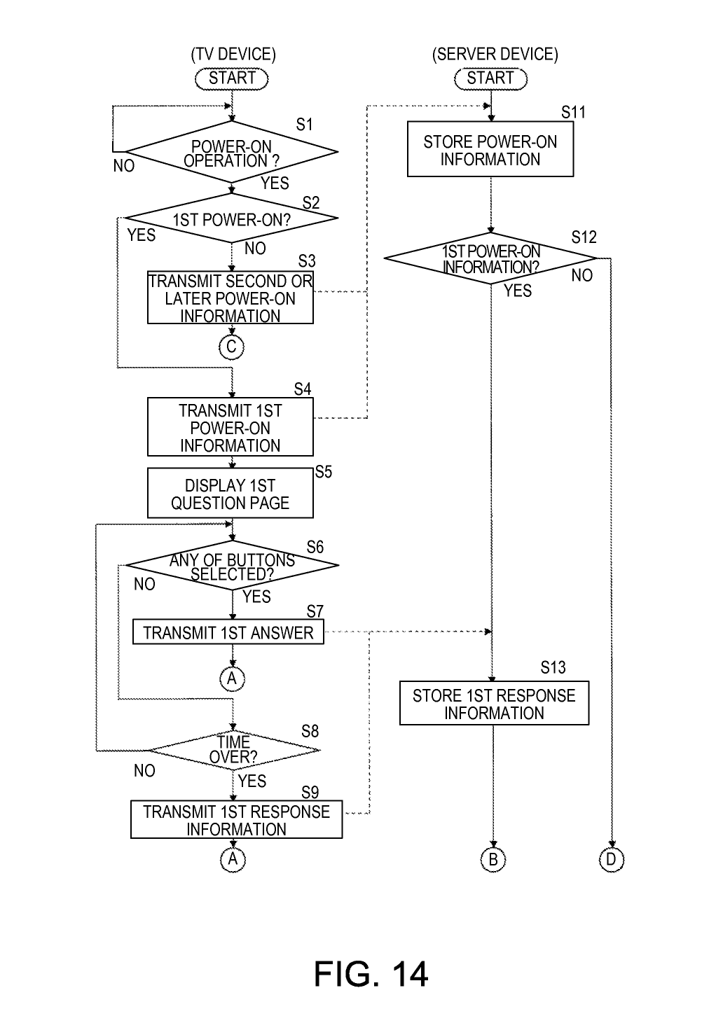

FIGS. 14 to 17 show, respectively, first to fourth flowcharts explaining chronological procedures of various processing items performed by the user state confirmation system 1 as described above (corresponding to procedures showing the contents of a user state confirmation method). Based on the first to fourth flowcharts, the procedures, etc., of various processing items performed by the television device 10, the server device 2, etc., linked to each other, are explained as below.

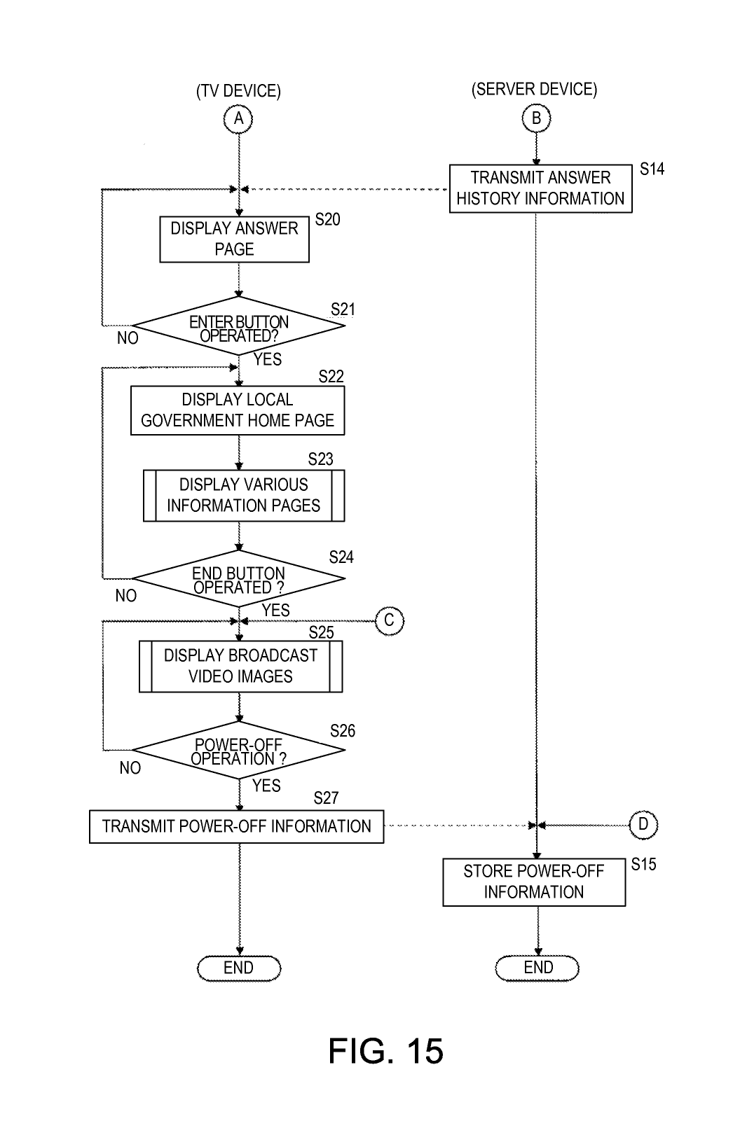

The first to third flowcharts of FIGS. 14 to 16 primarily show the processing of the server device 2 to obtain and accumulate the information of the state of monitored person. First, the television device 10 (the controller 14) determines whether or not there is the power-on operation (S1). If there is no power-on operation (S1: NO), the television device 10 waits for the power-on operation, and if there is the power-on operation (S1: YES), the television device 10 determines whether or not this is the first power-on operation of the day (S2), based on the determination whether or not the power-on flag of the memory 15 is set. If the power-on operation is determined not to be the first operation (S2: NO), the television device 10 transmits the second or later power-on information to the server device 2 together with the device identifier information I1 and the user ID (S3). Note that, in this case, the television device 10 proceeds to the stage “C” of the second flowchart of FIG. 15.

Moreover, if the power-on operation is determined to be the first operation (S2: YES), the television device 10 sets the power-on flag in the memory 15, and transmits the first power-on information to the server device 2 together with the device identifier information I1 and the user ID (S4).

In the meantime, upon receiving the (first, or second or later) power-on information from the television device 10, the server device 2 performs processing, by matching with the user ID received at the same time, to store the received power-on information to the box item of “power-on information” of a predetermined local government answer DB incorporated in the answer DB 6 (for example, the local government A's answer DB 6a) together with date and time of the reception (S11). Thereafter, the server device 2 determines whether or not the received power-on information is the first power-on information (S12), and if this is not the first power-on information (S12: NO), the server device 2 proceeds to the processing in the stage “D” of the second flowchart of FIG. 15. Moreover, if this is the first power-on information (S12: YES), the sever device 2 waits for the receiving of the next information (first response information).

Referring back to the processing of the television device 10, after S4, the television device 10 reads the indication parts data from the memory 15 and displays the first question page 21 as shown in FIG. 5a, on the display screen 10a (S5). Here, the television device 10 starts the time measurement from the indication of the first question page 21, and the television device 10 determines whether or not any of the first to third buttons 21a-21c, disposed in the first question page 21, is selected (S6). Upon receiving the selection of any of the buttons (S6: YES), the television device 10 transmits the first response information (first answer) to the server device 2, indicating the received answer of the selected button (S7).

Moreover, if none of the buttons is selected (S6: NO), then the television device 10 determines whether or not the measured time exceeds the threshold time period F to become the time over (S8). If this is not the time over (S8: NO), the television device returns to S6, and determines again whether or not any of the buttons is selected. If this is the time over (S8: YES), the television device 10 transmits the first response information to the server device 2, indicating that there is no response to the first question (S9).

In the state of waiting for the receiving of the next information, and upon receiving the first response information according to the first answer or the first response information indicating that there is no response to the first question, the server device 2 performs processing to store the received first response information in the box item of “first answer” of the same user ID described above, of the same local government response DB used in S11, associated with date and time of the reception (S13).

Thereafter, as shown in the second flowchart of FIG. 15, the server device 2 performs processing to read the first response information matching with the above user ID, together with date and time of the reception, from the box item “first answer” of the above local government answer DB for five days, to generate the answer history information for five days, and to transmit the information to the television device 10 (S14).

Upon receiving the answer history information, the television device 10 generates the answer page 22 as shown in FIG. 5(b) disposing the received answer history information, by using the indication parts data read from the memory 15, and displays the generated answer page 22 on the display screen 10a (S20). Note that, by automatically indicating the answer page 22, the monitored person can also make self-confirmation of the own state for the latest five days.

After indicating the answer page 22, the television device 10 determines whether or not the user operates the enter button 19g of the remote controller 10 (S21), and if the enter button 19g is not operated (S21: NO), the television device 10 returns to S20, and continues the indication of the answer page 22. On the other hand, if the enter button 19g is operated (S21: YES), the television device 10 accesses to the website of the local government service provider system as shown in FIG. 1, obtains the menu, etc., of the website home page, and by using the obtained menu, etc., and also by using the indication parts data read from the memory 15, generates the local government home page 23 as shown in FIG. 6(a), and displays on the display screen 10a (S22).

Thereafter, upon receiving the operation of any of the numeric buttons 20 and the back button of the remote controller 19, the television device 10 changes the indication appropriately to the living information page 24 of FIG. 6(b), the neighborhood community circle information page 25 of FIG. 7(a), etc., and displays various information pages on the display screen 10a based on the operation by the user (S23). Here, the television device 10 determines whether or not the end button 19h of the remote controller 19 is operated (S24). If the end button 19h is not operated (S24: NO), the television device 10 returns to S22, and displays the local government home page 23.

If the end button 19h is operated (S24: YES), or if the second or later power-on information is transmitted in the first flowchart of FIG. 14 (S3), then the television device 10 receives the broadcast signal of the last channel (the channel tuned in at the time of the last power-off operation), and displays the broadcast video images of that channel on the display screen 10a, and furthermore, upon the channel selection operation of the user, displays the broadcast video images of a predetermined channel on the display screen 10a (S25).

Here, the television device 10 determines whether or not there is the power-off operation by the user (S26). If there is no power-off operation (S26: NO), the television device 10 returns to S25, and continues the indication of the broadcast video images. On the other hand, if there is the power-off operation (S26: YES), the television device 10 transmits the power-off information to the server device 2 together with the device identifier information I1 and the user ID (S27). Note that, after transmitting the power-off information, the television device 10 stops activation of the device itself, and waits for the power-on operation.

Upon receiving the power-off information transmitted from the television device 10, the server device 2 stores the received power-off information, matching with the user ID received at the same time, in the box item of “power-off information” of the predetermined local government answer DB of the answer DB 6 (for example, the local government A's answer DB 6a), together with date and time of the reception (S15). Note that, in the case of specifications emphasizing the indication of the local government home page 23, after transmitting the second or later power-on information in the first flowchart of FIG. 14 (S3), instead of proceeding to the indication of the broadcast video images of the last channel (S25), it is possible to proceed to display the local government home page 23 (S22). Moreover, between the indication of various information pages (S23) and the determination of the end button operation (S24), it is also possible to provide the determination whether or not there is the operation of the back button, and if there is such an operation, the television device 10 may return to the indication of the local government home page 23 (S22). In this case, if there is no operation of the end button in S24 (S24: NO), the television device 10 returns to the indication of various information pages (S23).

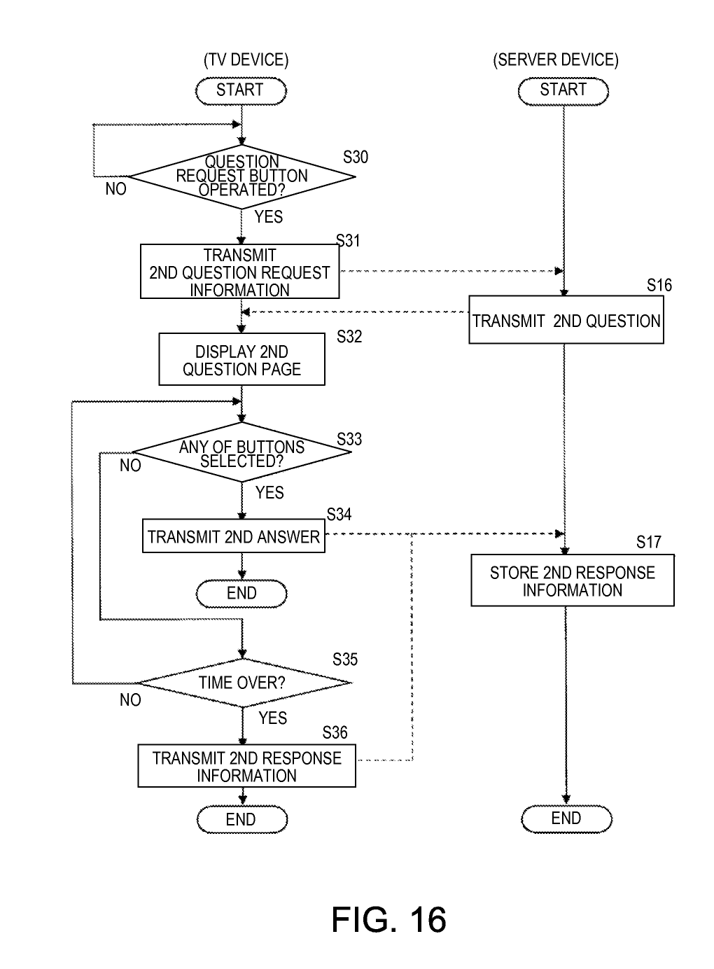

Moreover, in the third flowchart of FIG. 16, while the broadcast video images are displayed in S25 of the second flowchart of FIG. 15 as described above, etc., the television device 10 determines whether or not the user operated the question request button 19f of the remote controller 19 (S30). If the question request button 19f is not operated (S30: NO), the television device 10 waits for the operation, and if the question request button 19f is operated (S30: YES), the television device 10 transmits the second question request information to the server device 2, together with the device identifier information I1 and the user ID (S31).

Upon receiving the second question request information, in the answer DB 6, the server device 2 selects the second question matching with the contents stored in the box item “first answer” matching with the received user ID, from the second question candidates 7a to 7d stored in the second question DB 7 as shown in FIG. 11(a), and transmits the selected second question to the television device 10 (S16). Note that, at that time, the server device 2 stores the type of selected second question in the box item of “second question” of the answer DB 6.

Upon receiving the second question transmitted from the server device 2, by using that second question, the television device 10 generates the second question page 26 as shown in FIG. 7(b), and displays in the L-shaped form around the broadcast video images (S32). The subsequent procedures correspond to the case that the first question page 21 in the first flowchart of FIG. 14 is displayed, namely, the television device 10 starts the time measurement from the indication of the second question page 26, and determines whether or not any of the first to third buttons 26a-26c disposed in the second question page 26 is selected (S33). If any of the buttons is selected (S33: YES), the television device 10 transmits the second response information (second answer) indicating the answer of the selected button, to the server device 2 (S34).

Moreover, if none of the buttons is selected (S33: NO), then the television device 10 determines whether or not the measured time exceeds the threshold time period F to become the time over (S35). If this is not the time over (S35: NO), the television device returns to S33, and determines again whether or not any of the buttons is selected. If this is the time over (S35: YES), the television device 10 transmits the second response information to the server device 2, indicating that there is no response to the second question (S36).

Upon receiving the second response information according to the second answer or the second response information indicating that there is no response to the second question, the server device 2 performs processing to store the received second response information in the box item of “second answer” of the same local government response DB used in S16, associated with date and time of the reception (S17). With the processing as described above, the answer DB 6 of the server device 2 sequentially accumulates the information of the monitored person.

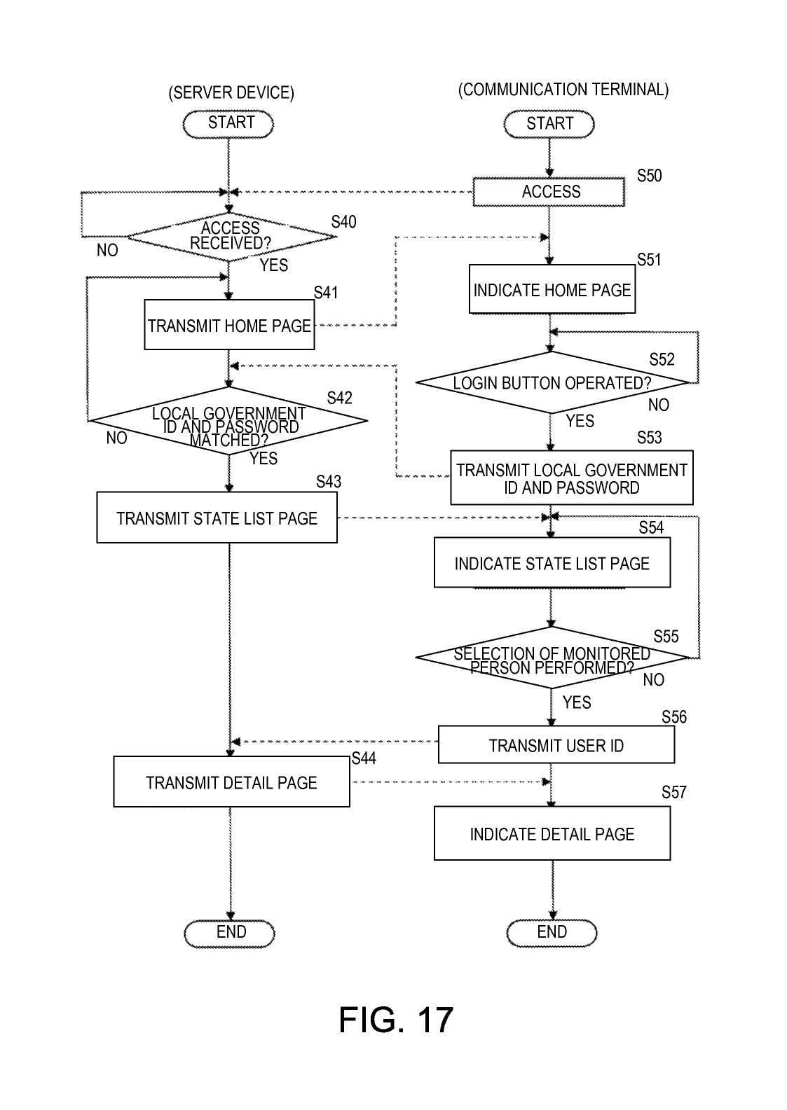

The fourth flowchart of FIG. 17 shows the processing, with the use of the communication terminal D1 by the monitoring person of the local government, to inspect the information of monitored person accumulated in the answer DB 6 of the server device 2, and to confirm the state of the monitored person. First, with the use of the communication terminal D1, the monitoring person K1 accesses to the URL of the watching service website operated by the server device 2 (S50), and the server device 2 determines whether or not the access is accepted (S40). If the access is not accepted yet (S40: NO), the server device 2 waits for the access, and if the access is accepted (S40: YES), the server device 2 transmits the page data of the home page 30 as shown in FIG. 12, to the accessing communication terminal D1 of the monitoring person K1 (S41).

Upon receiving the page data of the home page 30, the communication terminal D1 displays the home page 30 (S51), and determines whether or not the monitoring person K1 inputs the local government ID and the password, and thereafter whether or not the login button 30c is operated (S52). If the login button 30c is not operated (S52: NO), the communication terminal D1 waits for the operation of the login button 30c. On the other hand, if the login button 30c is operated (S52: YES), the communication terminal D1 transmits the local government ID and the password to the server device 2 (S53).

Upon receiving the local government ID and the password, the server device 2 determines whether or not there is the local government ID and the password in the registered local government DB 8 as shown in FIG. 11(b), matching with the received local government ID and the password (S42). If the received local government ID and the password do not match with those stored in the registered local government DB 8 (S42: NO), the server device 2 returns to the step of S41, and transmits the page data corresponding to the home page 30 indicating that the local government ID and the password do not match, to the communication terminal D1 (S43).

If the received local government ID and the password match with those stored in the registered local government DB 8 (S42: YES), the server device 2 specifies the local government answer DB (the latest version) of the matching local government ID from the answer DB 6, and determines the contents of television watching from the box items of “Watched TV within 3 hours,” “Watched TV within 24 hours,” “Watched TV yesterday” and “No TV watch for two days,” and generates the state list page 31 as shown in FIG. 13(a), including the determined contents, and the information in the box items “name” and “first answer” in the local government answer DB, and transmits the page data to the terminal device D1 (S43).

Upon receiving the page data, the communication terminal D1 displays the state list page 31 (S54). Accordingly, the monitoring person of the communication terminal D1 can confirm, at a glance, the state of a plurality of monitored persons of the day. Thereafter, with the operation by the monitoring person K1, the communication terminal D1 determines whether or not the selection of the monitored person in the list 31a of the state list page 31 is performed (S55). If there is no selection (S55: NO), the communication terminal D1 waits for the selection. If the selection is performed (S55: YES), the communication terminal D1 transmits the user ID (user information I2) of the selected monitored person to the server device 2 (S56).

Upon receiving the user ID (user information I2), the server device 2 reads the power-on time periods for several days (for example, one week) from the box “power-on time” of the answer DB 6, and transmits the page data of the detail page 32 as shown in FIG. 13(b) where the power-on time periods are disposed as the bar graphs, to the communication terminal D1 (S44).

Upon receiving the page data, the communication terminal D1 displays the detail page 32 (S57). With this processing, and by inspecting the state list page 31, the detail page 32, etc., the monitoring person K1 determines if there is any person who needs to be visited, among the plurality of monitored persons, and if any monitored person is determined to be visited, the monitoring person K1 notifies the watching persons K11, K12 of the neighborhood community circle or the local welfare commission as shown in FIG. 1 by telephone, email, etc., to request the visit. Upon receiving this request to visit, the watching persons K11, K12 visit and confirm the state of the monitored person directly.

In the present disclosure, with the processing as described above, the monitoring person K1 can confirm the state of the monitored person remotely, through linkage of the monitored person's television device 10 used on a day-to-day basis with the server device 2 of the cloud system, without installing any special sensor. Therefore the system can be constructed easier and at a considerably lower cost than conventional systems.

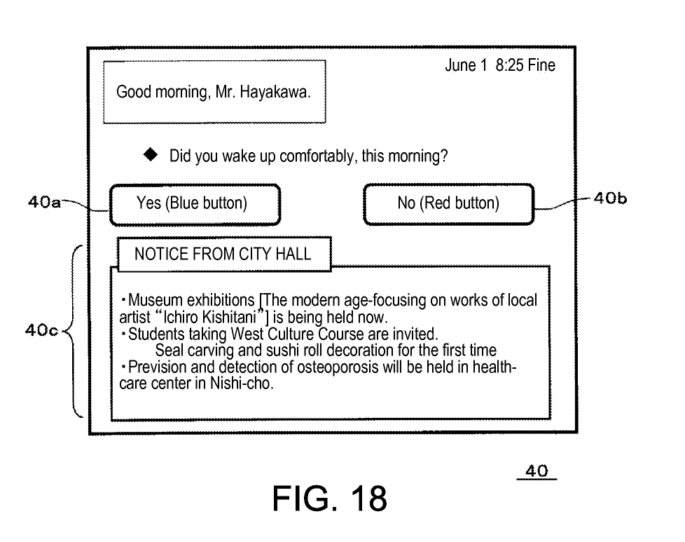

Note that, the present disclosure is not limited to the above embodiment, and various modifications exist. For example, other than embodiment of the first question page as shown in FIG. 5(a), as shown in a modification of FIG. 18, as the information provided from the server device 2 (notice information), it is also possible to apply a first question page 40 including local government information 40c. In order to display the first question page 40 in this modification, the server device 2 constantly crawls the local government service provider system and other information provider systems as shown in FIG. 1 and obtains the latest notice information, and stores the information in the mass storage system 2g. Upon receiving the power-on information from the television device 10, the server device 2 reads the latest notice information to be provided, and transmits that information to the television device 10. The television device 10 disposes and displays the received notice information in the read first question page, and thereby the first question page 40 in the modification of FIG. 18 can be provided to the monitored person.

It is advantageous that, since the first question page 40 includes useful information for the user, the user can be motivated to watch the first question page. Moreover, the first question page 40 includes a first button 40a and a second button 40b as the answers to the first question, and these buttons 40a, 40b are assigned to the blue button 19b and the red button 19c, respectively, of the remote controller 19.

As another modification, the first question disposed in the first question page 21 as shown in FIG. 5(a) is not stored in the television device 10, but may be stored in the server device 2. In this case, the mass storage system 2g of the server device 2 stores a various types of first question candidates in advance. These first question candidates have searching tags indicating the seasons, hours, the days of the week, health conditions, etc., and upon receiving the power-on information from the television device 10, the server device 2 performs processing to search among the plurality of first question candidates by using searching keywords such as the season at the time of receiving, the hour at the time of receiving, etc., to read the matching result as the first question, and to transmit that question to the television device 10.

Upon receiving the first question, the television device 10 generates the first question page disposing the received first question, and displays that first question page. In this modification, since the contents of question to the monitored person vary appropriately, the monitored person receives different question from day to day, and the boredom of questions can be avoided. Note that, in this modification, according to the types of stored answers to the first question candidates, the plural types of second questions DB 7 as shown in FIG. 11(a) are also to be prepared.

Moreover, the arrangement of the notice information as described above in the question page can also be applied to the second question page 26 of FIG. 7(b). In addition, when latest notice information is generated, the television device 10 may display the second question page with the notice information, by transmitting the page data of the second question page from the server device 2 to the television device 10. Accordingly, not only when the monitored person operates the question request button 19f of the remote controller 19, but also when the information to be notified is generated, the second question page can be displayed together with the watching broadcast video images, and the second question can be provided timely. Note that, as a form of the second question page, it is also possible to display together with the broadcast video images by so-called “picture in picture” or “picture out picture” function, and further, it is also possible to display in the same form as the first question page by switching the indication from the broadcast video images.

Further, it is also possible to provide selectable going out buttons such as “Going out today all day long,” “Going out for two days from tomorrow” and “Going out for three days from day after tomorrow” in the first question page or the second question page, and when any of these buttons is selected, the contents of the selected going out button may be transmitted to the server device 2. In this case, the server device 2 stores the transmitted number of days of going-out, etc., in the box item of “going out schedule” in the answer DB 6 together with date and time of the reception, so as to avoid erroneous determination that a mere going-out state is an emergent state incapable of turning on the television device 10.

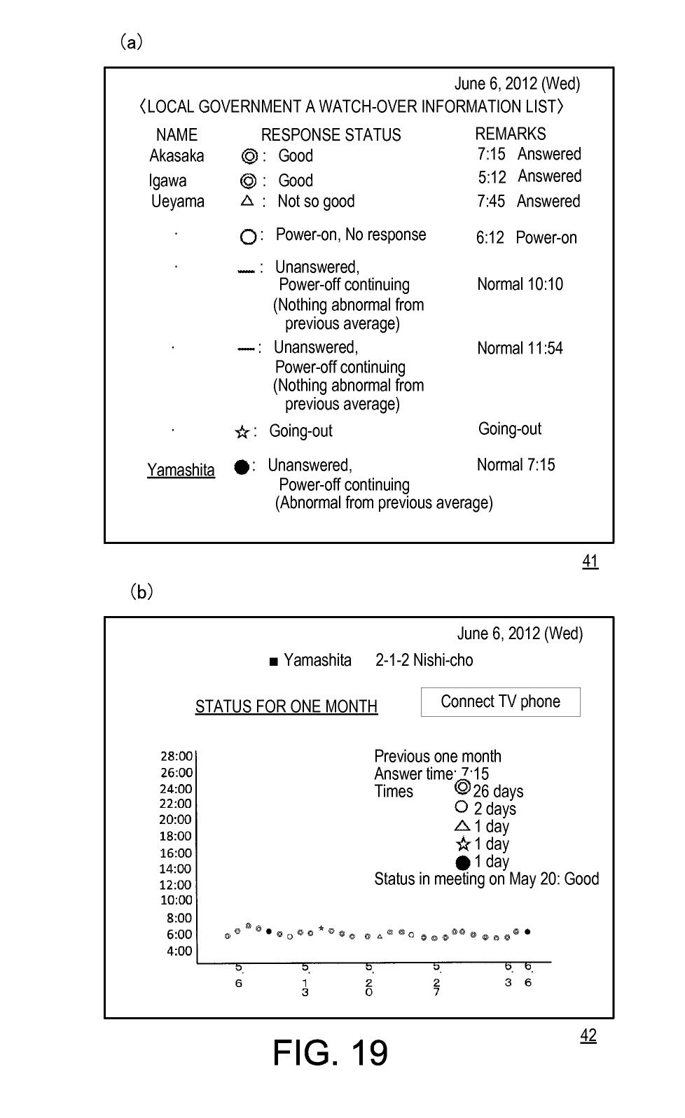

Moreover, the form of the state list page 31 as shown in FIG. 13(a) and the form of the detail page 32 as shown in FIG. 13(b) are mere examples, and in accordance with the specifications of the system and the demand from the local government, it is possible to display pages appropriately with disposing various types of information included in the answer DB 6, and for example, it is possible to apply forms of a state list page 41 as shown in FIG. 19(a), and a detail page 42 as shown in FIG. 19(b).

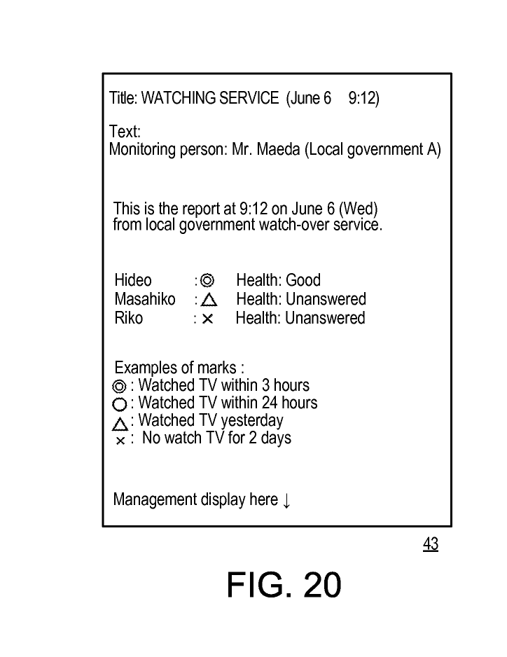

Moreover, the contents of the state list page or the detail page can be notified to the monitoring person K1 by email. For example, if there is no inspection by the monitoring person K1 for a predetermined period of time, it is possible to send an email (text message) from the server device 2 to the communication terminal D1 of the monitoring person K1. As examples of email, “Today, Mr. Akasaka answered ‘I woke up nicely’ at 7:15,” “To monitoring person of local government A: Today, at 9:38, not receiving the state of one person, Mrs. Yamashita,” etc., may be envisaged. Note that, as shown in FIG. 20, it is also possible to apply an email 43 including the contents corresponding to the state list page 31 of FIG. 13(a). Further, it is also possible to regularly send such an email notice, for example, the notice email can be sent from the server device 2 to the communication terminal device D1 of the monitoring person every day, at 9:00 AM.

Moreover, the television device 10 may be provided with a video phone function, so that the state can be confirmed by video phone before the direct visit of the neighborhood community circle or local welfare commission. In addition, the device used by the monitored person is not limited to the television device 10, and it is also possible to apply any device as long as it is provided with the communication function, the function of receiving the input operation by the user, and the function of outputting the information to the user, and of course, any communication terminal devices, for example, smart phones or portable phones, can be used instead of the television device 10. Radio devices without display can also be used (in the case of radio device, the information, the first question, the second question, etc., are outputted on the voice).

Further, although the first question page 21 as shown in FIG. 5(a) is explained for the case that the number of questions of the first question is one, it is also possible, of course, to include two or more questions in the first question. In this case, for example, a question text Q1 and a question text O2 are is indicated in the first question page, and for each question text, a plurality of answers are disposed together with check boxes, so that the user may tick any box considered as the answer to each question text. With this arrangement of two or more questions in the first question page, desirably, it is possible to confirm the physical and mental conditions of a user more in detail. Similarly, it is of course possible to provide two or more questions for the second question (second question candidates).

Moreover, when two or more questions are provided for the first question (or the second question), it is also possible that, a part of the two or more questions is stored in the server device 2, and another part of the two or more questions is stored in the television device 10 (communication terminal device), so that the television device 10 (communication terminal device) generates and outputs the first question (or the second question) by combining the part with the other part. In this case, upon receiving the power-on information, the server device 2 reads and transmits the part of question stored therein to the television device 10 (communication terminal device), and upon receiving the part of question, the television device 10 (communication terminal device) reads the other part of question stored therein, and generates and outputs the first question (or the second question) by combining the received part with the read, other part of the question.

In this modification, since the server device can arbitrarily change the contents of the part of question stored in the server device 2, the first question (second question) provided to the user is composed of the part of which contents of question vary arbitrarily, and the other part of which contents of question are fixed. Therefore, various types of contents of question to the user can be provided, so that the state of a user (physical and mental conditions of a user, etc.) can be confirmed more in detail.

Further, in the above explanation, although the second question is outputted with an interval from the time of first question, it is also possible to output the second question continuously after completion of the response from a user to the first question. In this case, after the user (monitored person) answers to the first question, upon depressing “enter” button in the answer page 22 as shown in FIG. 5(b), the second question request information indicating “Is there any second question?” is transmitted to the server device 2. Upon receiving this second question request information, the server device 2 determines whether or not there is a stored second question to be provided, and if the second question exists, the second question is transmitted to the television device 10, thereby the television device 10 can display the second question page following to the first question page. Note that, after the second question, if the third question, the fourth question and so forth exist, the third question and the subsequent questions may be displayed after the second question in a similar flow of processing.

Moreover, in the above explanation of the time over (threshold time period excess) of the answer to the first question or the second question, the television device 10 (communication terminal device) stores the threshold time period, so that the time over is determined by the television device 10 (communication terminal device). However, it is also possible that the server device 2 stores the threshold time period, so that the time over is determined by the server device 2. In this case, the server device 2 is set to transmit the first question, and to measure the time from transmission of the first question. If the measured time does not exceed the stored threshold time period, and when receiving the first response information transmitted from the television device 10, the server device 2 stores the received first response information. On the other hand, if the measured time exceeds the threshold time period without receiving the first response information, the server device 2 stores the first response information indicating that there is no response to the first question.

In addition, the notice information disposed in the first question page 40 as shown in FIG. 18 is not limited to be transmitted from the server device 2, and it is also possible that the television device 10 (communication terminal device) obtains original information from an external information provider system, etc. Furthermore, likewise the case of the second question page 26 as shown in FIG. 7(b), the first question page can also be displayed on the display screen 10a together with the television broadcast video images. As examples of the indication type in this case, it is envisaged that a pattern where the first question and the broadcast video images are disposed side by side, a pattern where the broadcast video images are disposed in the first question by “picture in picture” function, and the first question is disposed in the broadcast video images by “picture in picture” function, etc.

Moreover, as the pages of various questions, etc., displayed by the television device 10, various types of user interface indication can be applied, such as OSD, web browser, widget, etc. (it is also possible to use a module or an application program). Therefore, it is possible to adopt an appropriate indication type according to the demand for system specifications or device specifications, and furthermore, two or more types of indication can be combined. For example, it is possible to display the first question by browser, and to display the second question by OSD.

Further, in the above explanation, the determination whether or not this is the first power-on, or the second or later power-on, is based on the power-on flag stored in the memory 15 of the television device 10. However, it is also possible that, the server device 2 counts the number of transmissions of the power-on information to determine how many times the power is on. The server device 2 then transmits the determined result to the television device 10. In the case of determining how many times the power is on by the server device 2, it is also possible to adopt specifications, if this is the first power-on, that the server device 2 transmits the first question to the television device 10, and if this is the second or later power-on, that the server device 2 transmits the local government home page.

Moreover, of course, the user state confirmation system 1 of the present disclosure can be applied to any service other than the watching service by the local government. For example, if the parents and children live apart, the system can be constructed by assigning the parents as the monitored persons, and the children as the monitoring persons. In addition, depending on the structure of the user state confirmation system 1, other than to notify the information of the state of a user (contents of the state list page, the detail page, etc.) to the monitoring person K1 of the local government, it is also possible that the server device 2 notifies directly to the portable communication terminals of the watching persons K11, K12. In this case, it is preferable to notify the information by sending an email (see FIG. 20, etc.), but, of course, it is also possible to transmit necessary information via website, upon accepting access from the watching persons K11, K12, etc.

### Second Embodiment

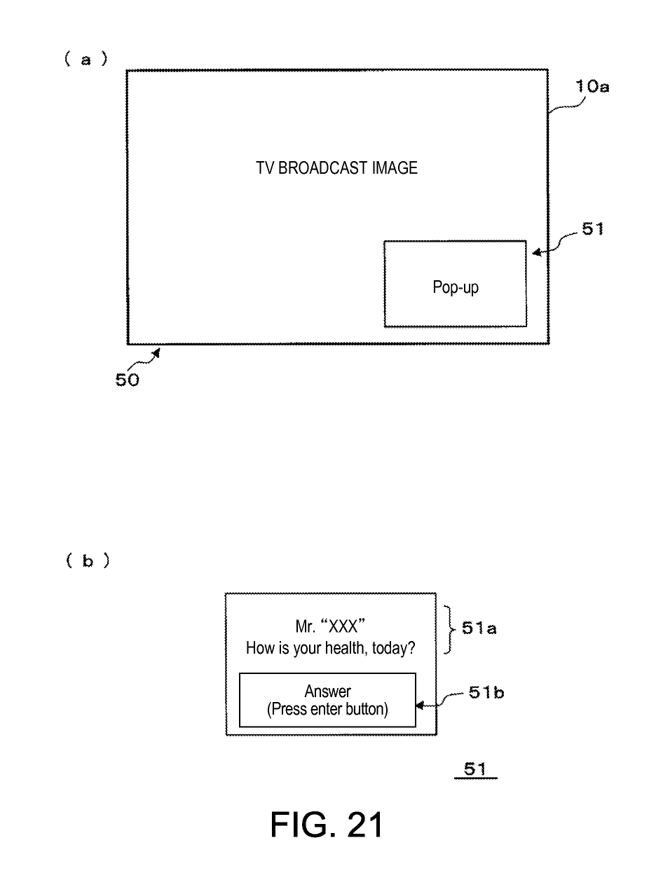

FIG. 21 shows a pop-up 51, as an example of preceding output displayed by the television device (communication terminal device) of the user state confirmation system in a second embodiment of the present disclosure. The second embodiment of the present disclosure is characterized in that, prior to the first question page 21 as shown in FIG. 5(a), the pop-up 51 is displayed, thereby the monitoring person can confirm the state of user (in particular, whether or not the user is alive, etc.) quickly. Note that, the structures of system and hardware in the second embodiment correspond to those in the first embodiment as described above, and the same reference signs are used for those corresponding to the first embodiment, for the explanation of the second embodiment.

The television device 10 (see FIG. 3) includes the controller 14, and since the watching program P2 defines various control processing items performed by the controller 14, the television device 10 is configured so that it can also be considered as a kind of computer. In the second embodiment, the television device 10 displays the pop-up 51 as shown in FIG. 21 on the display screen 10a, and therefore, the television device 10 stores the indication parts data (pop-up data) for indicating the pop-up 51, in the watching service display table T2 stored in the memory 15.

As shown in FIG. 21, since the pop-up data 51 includes a text part 51a and a selective button 51b, the pop-up data of the pop-up 51 includes data to display, in addition to the text part 51a, combined description data of the button 51b and background part, etc.

Likewise the case of the first question page 21 as shown in FIG. 5(a), the user name (or nickname) included in the user information I2 is read from the memory 15 and pasted on the part “XXX” in the text part 51a. Moreover, a words part of “this morning” included in the text part 51a is also pasted according to the time window, and the watching service display table T2 also includes other word parts such as “now,” “this afternoon” and “this evening.” Moreover, since the pop-up 51 has the button 51b, it indicates that the user can operate in accordance with the pop-up 51.

The memory 15 of the television device 10 stores the watching program P2 for the second embodiment for indicating the pop-up 51 as described above, and also stores a reference time period and a reference number of times for controlling the length of indication time and the number of times of indication of the displayed pop-up 51.

The reference time period means a time length set for indicating the pop-up 51, and for example, the time is set as 30 sec. However, likewise the case of the threshold time period F explained in the first embodiment, it is possible to set as a desired value between 5 sec. and 3 min. by an unillustrated set menu. Moreover, the reference number of times means a predetermined upper limit number of times to display the pop-up 51, and for example, the number is set as five times. However, likewise the case of the reference time period, it is possible to set as a desired number between once and fifteen times. Note that, when the monitoring person desires to confirm the state of a user quickly, it is desirable to set the reference time period as 30 sec. or less (preferably, between 10 sec. and 20 sec.), and to set the reference number of times as four or less. On the other hand, if the easy selection of the button 51b is important, it is desirable to set the reference time period as 30 sec. or more (preferably, between 40 sec. and 50 sec.), and to set the reference number of times as five or more.

The watching program P2 for the second embodiment adds processing to display the pop-up 51 to the contents of processing explained in the first embodiment. In particular, in the first embodiment, when the first power-on operation of the day is performed to the television device 10, the watching program P2 defines processing to transmit the first power-on information to the server device 2, and thereafter, to display the first question page 21 by the controller 14. On the other hand, in the second embodiment, the watching program P2 defines processing to transmit the first power-on information to the server device, and thereafter, to tune the tuner to the channel selected at the time of the last power-off operation, and to display the television broadcast video images of that channel on the display screen 10a by the controller 14, and further defines processing to read the pop-up data for the pop-up 51 from the memory 15, to generate the pop-up 51 based on the read pop-up data, and to emerge the generated pop-up 51 from the lower right corner of the display screen 10a by the controller 14. Note that, the reading of this pop-up data and the indication of the pop-up 51 are performed indirectly based on the first power-on operation of the day (similar in third and fourth embodiments described below).

Upon indication of the pop-up 51, the watching program P2 defines processing to measure (count) the passed time from the indication by the controller 14, and also processing to determine (detect) by the controller 14 whether or not the enter button 19g (corresponding to operation receptor) of the remote controller 19 (user interface) receives a depressing operation by the user, as indicated in the button 51b of the pop-up 51. Note that, the operation of the user to depress the enter button 19g of the remote controller 19 in response to the pop-up 51 displayed on the display screen 10a corresponds to the user response operation in response to the preceding output, and the enter button 19g of the remote controller 19 receives this response operation.

When the controller 14 detects that the enter button 19g receives the depressing operation, the watching program P2 defines processing to control by the controller 14, to transmit a “notice of the user operation” to the server device 2, together with the device identifier information I1 and the user ID, by using the communicator 17. By transmitting this notice, without waiting for the answer to the first question page 21 by the user in the first embodiment, at an earlier stage, the server device 2 can grasp quickly that the user is alive, and accordingly, the monitoring person (the monitoring person K1 of the local government A) can confirm quickly that the user is alive. Note that, when the enter button 19g receives the depressing operation by the user, the watching program P2 defines processing by the controller 14, starting from the indication of the first question page 21 as explained in the first embodiment.

On the other hand, if the controller 14 determines (detects) that the depressing operation of the enter button 19g is not received, the watching program P2 defines processing to compare the measured time with the reference time period stored in the memory 15, and to determine by the controller 14 whether or not the measured time exceeds the reference time period. The watching program P2 defines processing that, if the measured time does not exceed the reference time period, the controller 14 waits for the depressing operation of the enter button 19g by the user, and if the measured time exceeds the reference time period, the controller 14 controls to transmit “notice of no user operation” to the server device 2, together with the device identifier information I1 and the user ID, by using the communicator 17. With the transmission of this information, at an earlier stage, the server device 2 can grasp that there is a possibility of any abnormal state of the user, and accordingly, the monitoring person (the monitoring person K1 of the local government A) can be ready for the abnormal state of the user smoothly.

Upon transmitting “notice of no user operation,” the controller 14 defines processing to stop the indication of the pop-up 51 temporarily, to count one time of the indication of the pop-up and to store that count in the memory 15, and to compare the number of counts stored in the memory 15 with the reference number of times stored in the memory 15. The watching program P2 defines processing by the controller 14 that, if the number of counts does not exceed the reference number of times, after passing of a predetermined time (for example, 5 sec.), the pop-up 51 is displayed again, and thereafter, the processing items as described above are repeated. Note that, the predetermined time value is also stored in the memory 15, and an appropriate time value approximately between 1 sec. and 3 min. is set and stored likewise the case of the reference time period as described above.

Again, because of the repeated indication of the pop-up 51 and the repeated transmission of the “notice of no user operation,” if the depressing operation of the enter button 19g by the user is not received after the number of counts exceeds the reference number of times, the watching program P2 defines processing to control by the controller 14 to transmit “notice of a user abnormal state” to the server device 2, together with the device identifier information I1 and the user ID, by using the communicator 17. For reference, the state that the depressing operation of the enter button 19g by the user is not received in spite of repeated indication of the pop-up 51, is considered as the state in which the user is unable to operate the enter button 19g of the remote controller 19, and therefore “notice of a user abnormal state” as described above is transmitted. Moreover, by transmitting this notice, the server device 2 can grasp, at an earlier stage, that the user is in the critical condition, and accordingly, it is advantageous that the monitoring person (the monitoring person K1 of the local government A) can be ready for coping with the user in the critical condition quickly. Note that, other than the contents as described above, the television device 10 of the second embodiment performs the processing corresponding to the first embodiment.

In the meantime, since the television device 10 transmits “notice of a user operation reception,” “notice of no user operation” or “notice of a user abnormal state” as described above, the server device 2 of the second embodiment determines whether or not the contents of these transmissions are received, and upon receiving, the contents are saved, together with date and time of the reception, in the answer DB 6 stored in the mass storage system 2g (see FIG. 8) per user, and the watching service program 4 of the second embodiment freshly defines this saving processing. Moreover, likewise the contents of the answer of the first embodiment, the server device 2 also distributes the contents of these transmissions included in the state list page or the detail page, and the watching service program 4 of the second embodiment also defines this processing freshly.

Moreover, upon receiving “notice of a user abnormal state,” since the immediate response is required, the server device 2 notifies the monitoring person by email that the user is in the abnormal state, and for that purpose, the user DB 5 in the second embodiment (see FIGS. 8, 9) stores, in association with “user ID,” not only “name,” “nickname,” etc., of the user, but also the communication address of the television device 10 of the user, the email address of communication terminal device used by the monitoring person, etc.

For that purpose, upon the server device 2 receiving the “notice of a user abnormal state,” the watching service program 4 of the second embodiment freshly defines processing to also receive the device identifier information I1 and the user ID transmitted from the television device 10 together with that notice, to specify the email address of the communication terminal D1 by the user DB used by the monitoring person K1 matching with the received user ID, to prepare automatically an email instructing (in a fixed text) that the monitored person must be visited immediately, and to transmit the email to the specified email address. Note that, the mass storage system 2g of the server device 2 of the second embodiment also stores such a fixed text for the email. Moreover, upon receiving the email with the above instruction, the monitoring person K1 contacts the watching persons K11, K12 by telephone calls, etc., to instruct them to immediately go to the monitored person′ house to see the state of the monitored person (user).

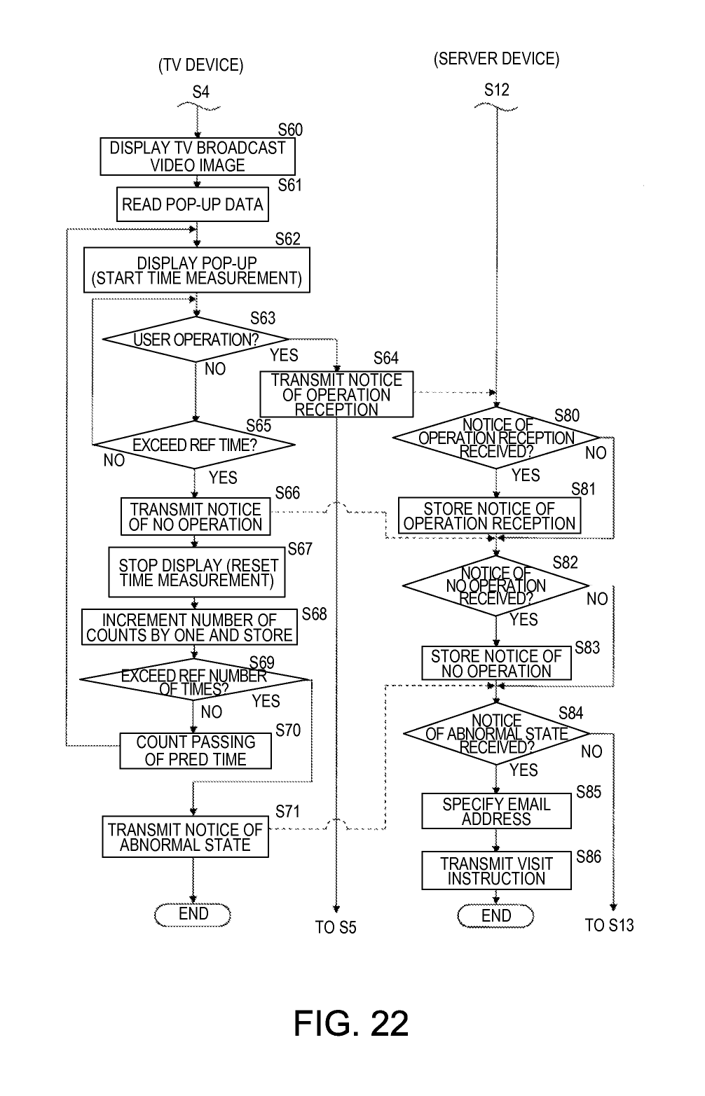

FIG. 22 is a fifth flowchart showing processing of the television device 10 and the server device 2 in the second embodiment as described above. The fifth flowchart shows the processing of the second embodiment added to the first flowchart of FIG. 14 as explained in the first embodiment. In particular, processing items Step S60-S71 of the television device in the fifth flowchart are added to the stage between Step S4 (First power-on information transmission) and Step S5 (First question page indication) of the television device in the first flowchart, and processing items Step S80-S86 of the server device in the fifth flowchart are added to the stage between Step S12: YES (First power-on information?: YES) and Step S13 (First response information storing) of the server device in the first flowchart.

The linked processing of the television device 10 and the server device 2 in the second embodiment is explained with reference to the fifth flowchart. First, after transmitting the first power-on information (S4), the television device 10 tunes in to the channel at the time of the last power-off, etc., and displays the television broadcast video images on the display screen 10a (S60), and in addition, reads the pop-up data of the pop-up 51 from the watching service display table T2 of the memory 15 (S61), and displays the pop-up 51 emerging from the lower right corner of the display screen 10a, superimposing on the indicating broadcast video images (S62). Note that, after indicating the pop-up 51, the television device 10 starts measurement (counting) of the passed time.

Thereafter, the television device 10 determines whether or not the user operation in response to the button 51b of the pop-up 51 (the depressing operation of the enter button 19g of the remote controller 19) is received (S63). If the user operation is received (S63: YES), the television device 10 transmits the notice of a user operation reception to the server device 2 (S64). Note that, after transmitting the notice of a user operation reception, the television device 10 proceeds to Step S5 in the first flowchart of FIG. 14, and displays the first question 21 of FIG. 5(a) on the display screen 10a.

In response to the processing of the television device 10 as described above, the server device 2 determines whether or not the notice of a user operation reception is received (S80), and if received (S80: YES), the received notice of a user operation reception per user is stored in the answer DB 6 of the mass storage system 2g (see FIG. 8) together with date and time of the reception (S81). Note that, if not received (S80: NO), the server device 2 does not perform any particular processing, and proceeds to the next stage.

Referring back to the processing of the television device 10, if there is no user operation (S63: NO), the television device 10 determines whether or not the measured time exceeds the reference time period (S65), and if no excess of the reference time period (S65: NO), the television device 10 returns to the determination of whether or not the user operation is received (S63), and thereafter, waits for the user operation reception until the excess of the reference time period.

If the measured time exceeds the reference time period (S65: YES), the television device 10 transmits the notice of no user operation to the server device 2 (S66). In response to this notice transmission, the server device 2 determines whether or not the notice of no user operation is received (S82), and if received (S82: YES), the received notice of no user operation is stored per user in the answer DB 6 of the mass storage system 2g (see FIG. 8) together with date and time of the reception (S83). Note that, if not received (S82: NO), the server device 2 proceeds to the next stage without performing any particular processing.

Referring back to the processing of the television device 10, the television device 10 stops the display of the pop-up 51 (S67), and accordingly, pauses the measurement of time, and also resets the measured time to zero. Thereafter, the television device 10 increments the number of indications (number of counts) of the pop-up 51 by one, and stores the current number of counts in the memory 15 (S68). Here, the television device 10 determines whether or not the current number of counts exceeds the reference number of times (S69), and if no exceeding (S69: NO), after counting passing of a predetermined time (for example, 5 sec.) (S70), the television device 10 returns to the indication of pop-up (S62), and thereby the television device 10 displays the pop-up 51 again.

After the pop-up 51 is displayed again, if there is no user operation, and if the number of counts does not exceed the reference number of times, the television device 10 repeats the processing to transmit the notice of no user operation (S66), to stop the display of the pop-up 51 (S67) and to display the pop-up 51 again (S62) as described above.

On the other hand, if the current number of counts exceeds the reference number of times (S69: YES), the television device 10 resets the current number of counts to zero, and transmits “notice of a user abnormal state” to the server device 2 (S71). Upon transmitting “notice of a user abnormal state,” the processing by the television device 10 ends, and the power is turned to off automatically.

Moreover, in response to the transmission of “notice of a user abnormal state” from the television device 10 as described above, the server device 2 determines whether or not “notice of a user abnormal state” is received (S84). If received (S84: YES), the server device 2 specifies the email address of the monitoring person matching with the user ID, etc., transmitted together with the notice (S85), automatically prepares the email instructing the necessity of immediately visit to that monitored person, and transmits that email to the specified email address (S86), and at this point, the processing of this time ends temporarily. On the other hand, if “notice of a user abnormal state” is not received (S84: NO), the server device 2 proceeds to Step S13 in the first flowchart of FIG. 14.

As explained above, in the user state confirmation system of the second embodiment, in response to the power-on operation of the television device 10, the first question page 21 of FIG. 5(a) is not displayed directly, but instead, prior to the first question page 21, the pop-up 51 of FIGS. 21(a) and (b) is displayed. Therefore, as an interim response to the pop-up 51, it is enough for the monitored person to depress the enter button 19g of the remote controller 19, and the subsequent processing can be performed. Accordingly, the system can provide the monitored person (user) with an opportunity to start the operation quickly, without requesting answer to the question (i.e., without requesting thinking) such as the first question page 21, and therefore, can confirm the state of a user quickly by determining whether or not there is the user operation.

Note that, the second embodiment of the present disclosure is not limited to the above contents, and various modifications can be provided. For example, as a form of indication of the pop-up 51, other than the emerging from the lower right corner of the display screen 10a, it is also possible to emerge from any other part of the display screen 10a, and for the purpose of drawing the attention of the user (monitored person), it is also possible to display the pop-up 51 with blinking, or to display the pop-up 51 moving around on the display screen 10a. In addition, for the purpose that the user surely watches the pop-up 51, it is also effective to enlarge the size of the pop-up 51 so as to make superimposed broadcast video images 50 less visible, and the maximum size of the pop-up 51 can be the fill-screen size of the display screen 10a.

Moreover, the text part 51a of the pop-up 51 may include the contents, not only in the style of question style as described above, but also in the style of request or instruction to the user such as “Press this button,” or in the style of quiz such as “What′ your fortune today?” The important thing is to encourage the user to operate the button first of all, in order to confirm if the user (monitored person) is alive.

In addition, in the fifth flowchart of FIG. 22 as described above, the television device 10 compares the reference time period with the waiting time for the user operation in response to the pop-up 51, and also compares the reference number of times with the number of repeated indications of the pop-up 51. However, it is also possible to perform processing of these comparisons by the server device 2.

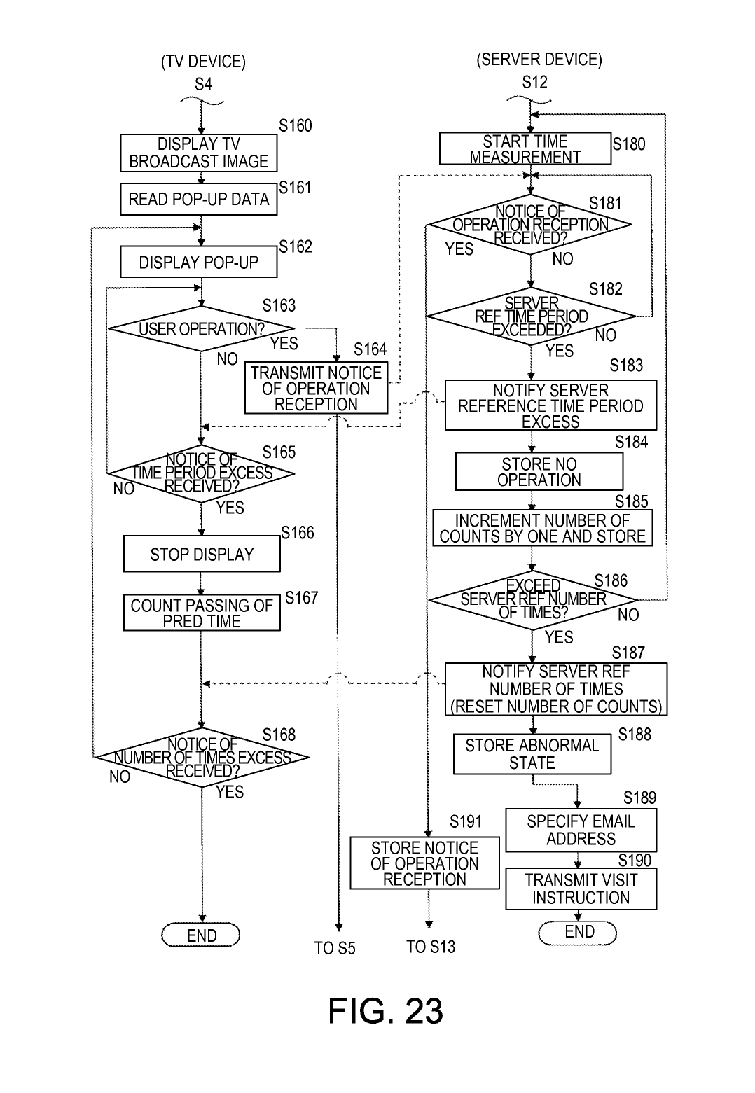

FIG. 23 is a sixth flowchart showing processing in a modification of the second embodiment, in which the server device 2 performs comparisons with the reference time period and the reference number of times. In the modification of the sixth flowchart, as compared with the fifth flowchart of FIG. 22, the television device 10 omits processing such as the time measurement, the determination of excess of the reference time period (Step S65 in the fifth flowchart), the transmission of the notice of no user operation (Step S66 in the fifth flowchart), the increment of the counted number of repeats by one (Step S68 in the fifth flowchart), the determination of excess of the reference number of times (Step S69 in the fifth flowchart), and the transmission of the notice of abnormal state (Step S71 in the fifth flowchart).

Therefore, the television device 10 in this modification does not require storing of the reference time period and the reference number of times, and further, the watching program P2, defining the processing items of the controller 14, is configured by deleting from predetermined processing items, the processing items which are also omitted from the fifth flowchart as described above. Moreover, other than the deletion of the above processing items, the watching program P2 changes several definitions of processing. For example, in the determination of the time waiting for the user operation in response to the pop-up 51, the watching program P2 determines based on a notice of server reference time period excess transmitted from the server device 2 (see Step S165 in the sixth flowchart), and in addition, in the determination of the re-indication of the pop-up 51, the watching program P2 determines based on a notice of server reference number of times excess transmitted from the server device 2 (see Step S168 in the sixth flowchart).

In the meantime, the server device 2 according to this modification performs processing items instead, that are omitted in the television device 10 as described above. As compared with the fifth flowchart of FIG. 22, the server device 2 additionally performs each processing item, such as the time measurement processing item (Step S180 in the sixth flowchart), the determination of excess of the server reference time period (Step S182 in the sixth flowchart), the notice of excess of the server reference time period (Step S183 in the sixth flowchart), the increment of the counted number of repeats by one (Step S185 in the sixth flowchart), the determination of excess of the server reference number of times (Step S186 in the sixth flowchart), and the notice of excess of the server reference number of times (Step S187 in the sixth flowchart).

Therefore, in the server device 2 of the modification, the RAM 2c or the mass storage system 2g stores the server reference time period, as the standard of waiting time for the user operation in response to the pop-up 51, and also stores the server reference number of times, as the standard of number of times of re-indication of the pop-up 51. For reference, the server reference time period responds to the reference time period of the television device 10 as described above, and the time corresponding to the reference time period can be applied. Also, the server reference number of times responds to the reference number of times of the television device 10, and the value corresponding to the reference number of times can be applied. Moreover, in the watching service program 4 defining various processing items related to the watching service of the MPU 2a as described above, the added processing items as compared with the fifth flowchart as described above are also added to the predetermined processing items. Further, with these additions, there are changes in the flow of processing defined by the watching service program P4, and the additions and changes of the flow of processing are explained in the sixth flowchart of FIG. 23 below.

In the sixth flowchart of FIG. 23, first, the television device 10 performs processing from Step S160 to Step S164, basically in the similar manner as that from Step S60 to Step S64 of the fifth flowchart of FIG. 22, but the starting of measurement (counting) of the passed time is omitted in Step S162.

In the meantime, if the power-on information transmitted from the television device 10 is the first information of the day (Step S12 in the first flowchart: YES), the server device 2 performs processing by the MPU 2a, to start the measurement of time (S180), and to determine whether or not the notice of a user operation reception from the television device 10 is received or not (S181) as a first processor. If the notice of a user operation reception is received (S181: YES), the server device 2 stores the received notice of a user operation reception per user, in the answer DB 6 of the mass storage system 2g (see FIG. 8) together with date and time of the reception (S191). Thereafter, likewise the case of the fifth flowchart, the server device 2 proceeds to Step S13 in the first flowchart.

Moreover, if the notice of a user operation reception is not received (S181: NO), the server device 2 determines whether or not the measured time exceeds the server reference time period or not (S182), and if not exceeding (S182: NO), the server device 2 returns to Step S181 and waits for the notice of a user operation reception. On the other hand, if the measured time exceeds the server reference time period without receiving the notice of a user operation reception (S182: YES), as a second processor, the MPU 2a of the server device 2 performs processing to transmit the notice of server reference time period excess to the television device 10 (S183), and resets the measured time to zero temporarily.

If the user operation in response to the pop-up 51 is not received (S163: NO), then the television device 10 determines whether or not the notice of server reference time period excess from the server device 2 is received (S165), and if not received (S165: NO), the television device 10 returns to Step S163, and waits for the user operation reception. On the other hand, if the notice of server reference time period excess is received (S165: YES), the television device 10 stops a display of the pop-up 51 temporarily (S166), counts the passing of a predetermined time (for example, 5 sec.) (S167), and determines whether or not the notice of server reference number of times excess from the server device 2 is received (S168).

In the meantime, after transmitting the notice of server reference time period excess to the television device 10, the server device 2 stores that there is no user operation in response to the pop-up 51, in the answer DB 6 of the mass storage system 2g (see FIG. 8) together with date and time of the reception (S184), increments the number of repeated processing items (number of counts) by one, and stores the current number of counts in the RAM 2c (S185). Thereafter, the server device 2 determines whether or not the current number of counts exceeds the server reference number of times (S186).

If the current number of counts does not exceed the server reference number of times (S186: NO), the MPU 2a of the server device 2 performs processing, as a third processing measures, to return to the starting of the time measurement (S180) to perform the time measurement again, and via processing items as described above, from the time reset associated with transmission of the notice of server reference time period excess (S183) to the determination of server reference number of times excess in Step S186, to return to the time measurement again (S180). If the notice of a user operation reception from the television device 10 is not received, the server device 2 repeats the processing, from the first processor to the third processor as described above.

With the repeated processing of the first processor to the third processor as described above, if the current number of counts exceeds the server reference number of times (S186: YES), the server device 2 transmits the notice of server reference number of times excess to the television device 10, and resets the number of counts to zero temporarily (S187). Here, since this state is considered to be an abnormal state in which the user is unable to operate in response to the pop-up 51, the server device 2 stores the occurrence of a user abnormal state in the answer DB 6 together with the determined date and time (S188), and thereafter, the server device 2 performs processing, likewise the case of Step S85, S86 in the first flowchart of FIG. 22, to specify the email address of the monitoring person (S189), to prepare the email automatically instructing the necessity of visit to the monitored person immediately, and to transmit that email to the specified email address (S190), and at this point, the processing of this time ends temporarily.

Further, when the notice of server reference number of times excess from the server device 2 is not received (S168: NO), the television device 10 returns to the indication of the pop-up 51 (S162), and the pop-up 51 is displayed on the display screen 10a again. Therefore, while the notice of server reference number of times excess is not received, the indication and clearing of pop-up are repeated, and with this repeated indication of the pop-up 51 on the display screen 10a, the user is attracted and encouraged to perform the response operation. Moreover, upon receiving the notice of server reference number of times excess from the server device 2 (S168: YES), the television device 10 ends the processing temporarily.

In the processing of the six flowchart of FIG. 23 as described above, as compared with the fifth flowchart of FIG. 22, the processing load on the television device 10 can be reduced. Moreover, in the processing of the sixth flowchart, the number of transmissions from the television device 10 to the server device 2 can be smaller than the case of the fifth flowchart. Therefore, even in the case of having difficulties in transmitting from the communication terminal device to the server device for some reasons, the processing in the sixth flowchart can be utilized suitably.

In addition, in the above explanation, the pop-up 51 is displayed for a predetermined time, and if there is no user operation, the indication is paused temporarily, and thereafter, the indication is outputted again repeatedly. However, of course, it is also possible to maintain the indication of the pop-up 51 continuously.

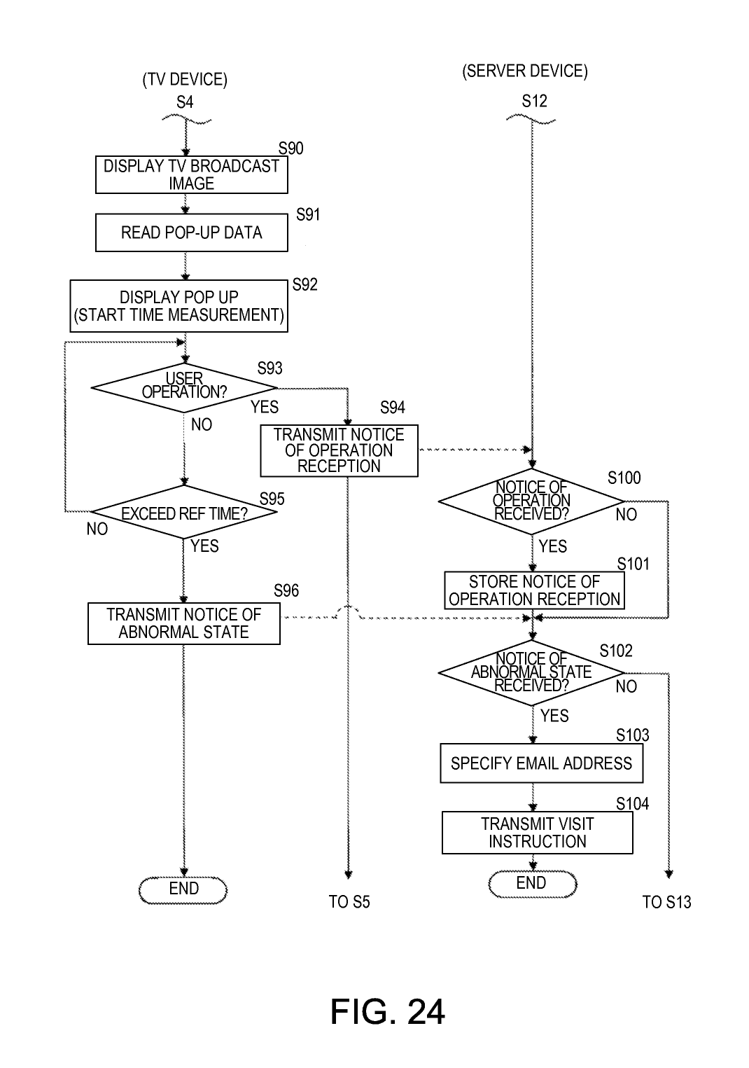

FIG. 24 is a seventh flowchart showing processing in a modification of the second embodiment, explaining the flow of procedures in the case of continuous indication of the pop-up 51. In this modification, since the reference time period as described above is the maximum time for indicating the pop-up 51, the set value for the reference time period is longer than the case as described above, and for example, it is desirable to set the value between 1 min. and 5 min. Moreover, in this modification, since the pop-up 51 is not displayed repeatedly, the setting and processing of the reference number of times are not required.

In the modification of FIG. 24, first, likewise the case of the fifth flowchart of FIG. 22, and also likewise the contents of processing from Step S60 to Step S63, the television device 10 performs processing from Step S90 to Step S93. Moreover, if there is the user operation in response to the displayed pop-up (S93: YES), similarly, the television device 10 transmits the notice of a user operation reception to the server device 2 (S94), and in response to transmission of this notice, the server device 2 also performs processing (S100, S101) likewise the case of the fifth flowchart as described above.

On the other hand, if there is no user operation (S93: NO), the television device 10 determines whether or not the time from indication of the pop-up 51 (measured time) exceeds the reference time period (S95), and if not exceeding the reference time period (S95: NO), the television device 10 returns to determine whether or not the user operation is received (S93), and waits for the user operation reception until exceeding the reference time period. Note that, in this waiting state, the pop-up 51 is maintained to display continuously. Here, in the case of excess of the reference time period (S95: YES), the television device 10 resets the measured tome to zero, and transmits the “notice of a user abnormal state” to the server device 2 (S96). Accordingly, the television device 10 ends the processing temporarily, and in response to transmission of this notice, the server device 2 also performs the processing (S102-S104) likewise the case of the fifth flowchart as described above.

In the modification of FIG. 24, as compared with the processing of FIG. 22, since the processing related to the transmission of the “notice of no user operation” is omitted, the processing items can be simplified, and further, since the indication of the pop-up 51 is maintained continuously, it is desirable to provide the user (monitored person) with the opportunity to perform the operation anytime.

Furthermore, even in the case of continuous indication of the pop-up 51 as shown in the seventh flowchart of FIG. 24, likewise the case of the sixth flowchart of FIG. 23, it is also possible to assign the server device 2 with the burden of processing to determine the excess of the reference time period, etc.

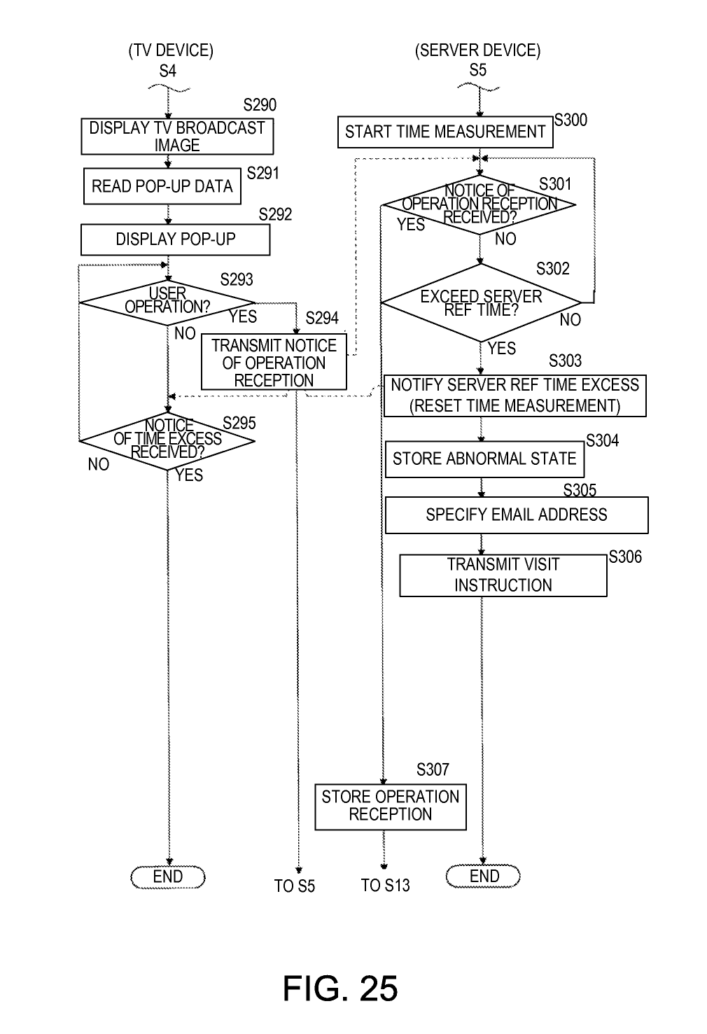

FIG. 25 is an eighth flowchart showing a modification, in which, in contrast to the case of continuous indication of the pop-up 51 in the seventh flowchart, the server device 2 performs processing such as the determination of excess of the reference time period, etc. In this modification, the television device 10 and the server device 2 perform the processing corresponding to that as explained in the sixth flowchart of FIG. 23, and the server device 2 performs processing such as the storing of the server reference time period (applying the time corresponding to the reference time period used in the seventh flowchart). The processing of the television device 10 from Step S290 to Step S294 is basically similar to that in the seventh flowchart of FIG. 24, but in Step S292, the starting of measurement of passed time (time counting) is omitted.

In the meantime, likewise the case from Step S180 to Step S183 of the six flowchart of FIG. 23 as described above, the server device 2 performs processing, from measurement of time in Step S300 to transmission of the notice of sever reference time period excess in Step S303. Note that, in Step S301, upon receiving the notice of a user operation reception from the television device 10 (S301: YES), the server device 2 stores the received notice of a user operation reception per user, in the answer DB 6 of the mass storage system 2g together with date and time of the reception (S307), and thereafter, proceeds to Step S13 in the first flowchart.

Moreover, upon transmitting the notice of time excess in Step S303, the server device 2 stores the occurrence of a user abnormal state in the answer DB 6 of the mass storage system 2g (see FIG. 8) together with the determined date and time (S304), and thereafter, the server device 2 performs processing, likewise the case the first, fifth and sixth flowcharts, to specify the email address of the monitoring person (S305), to prepare the email automatically instructing the necessity of visit to the monitored person immediately, and to transmit that email to the specified email address (S306), and at this point, the processing of this time ends temporarily.

If there is no user operation (S293: NO), the television device 10 determines whether or not the notice of server reference time period excess from the server device 2 is received (S295), and if not received (S295: NO), the television device 10 returns to determine whether or not there is the user operation (S293), and repeats processing from Step S293 to Step S295 while there is no user operation. Accordingly, the indication of the pop-up 51 is maintained continuously, by maintaining the continuous output of the pop-up data displayed in Step S292. Moreover, at the point of receiving the notice of excess of the server reference time period (S295: YES), the television device 10 ends the processing of this time temporarily. Therefore, even in the case of continuous indication of the pop-up 51, the server device 2 performs such as the determination of the reference time period excess, etc., thereby the number of transmissions from the television device 10 to the server device 2 can be reduced.

In addition, a further modification can be provided in which, the television device 10 and the server device 2 do not synchronize with each other for the processing such as the repeated indication of the pop-up 51 and the determination of occurrence of abnormal state based on the user operation reception, but instead, the television device 10 and the server device 2 perform separate processing independently.

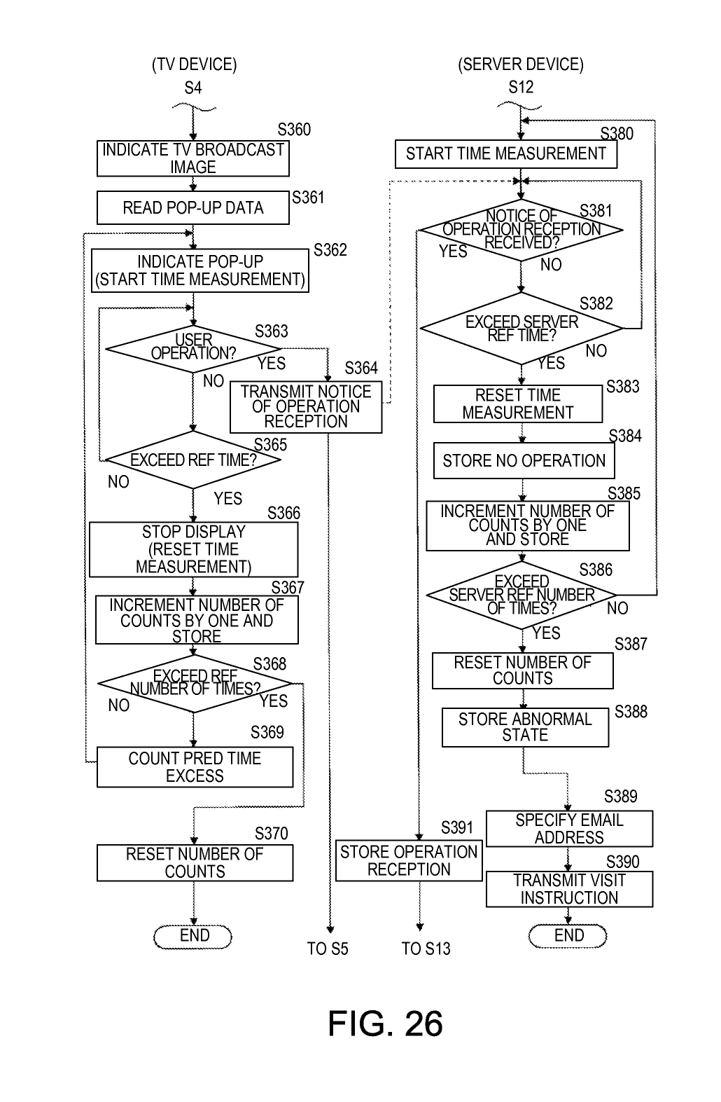

FIG. 26 shows a ninth flowchart, in which the television device 10 and the server device 2 do not synchronize with each other, but perform separate processing independently. For the processing in the ninth flowchart of FIG. 26, the television device 10 stores the reference time period and the reference number of times likewise the case of the fifth flowchart of FIG. 22. In the ninth flowchart of FIG. 26, the television device 10 performs processing from Step S360 to Step S370, that basically corresponds to the processing of the television device 10 from Step S60 to Step S71 in the fifth flowchart of FIG. 22, except for the omission of processing to transmit the notices to the server device 2, namely the transmission of the notice of no user operation (S66) and the transmission of the notice of a user abnormal state (S71).

In the meantime, for the processing in the ninth flowchart of FIG. 26, the server device 2 stores the server reference time period and the server reference number of times likewise the case of the sixth flowchart of FIG. 23. Moreover, in the ninth flowchart of FIG. 26, the server device 2 performs processing from Step S380 to Step S391, that basically corresponds to the processing of the server device 2 from Step S180 to Step S191 in the sixth flowchart of FIG. 23, except for the omission of processing to transmit the notices to the television device 10, namely the transmission of the notice of server reference time period excess (S183) and the transmission of the notice of server reference number of times excess (S187).

As described above, in the processing of the ninth flowchart of FIG. 26, the television device 10 performs processing of the repeated indication of the pop-up 51 independently, and the server device 2 performs processing of the determination of occurrence of abnormal state independently. Therefore, except for the transmission of the notice of a user operation reception (S364), the transmission of notices to each other is eliminated and the synchronization processing is omitted, and accordingly, it is advantageous that unnecessary communication can be restrained at the lowest possible, and a predetermined processing can be performed even in a place of poor communication environments.

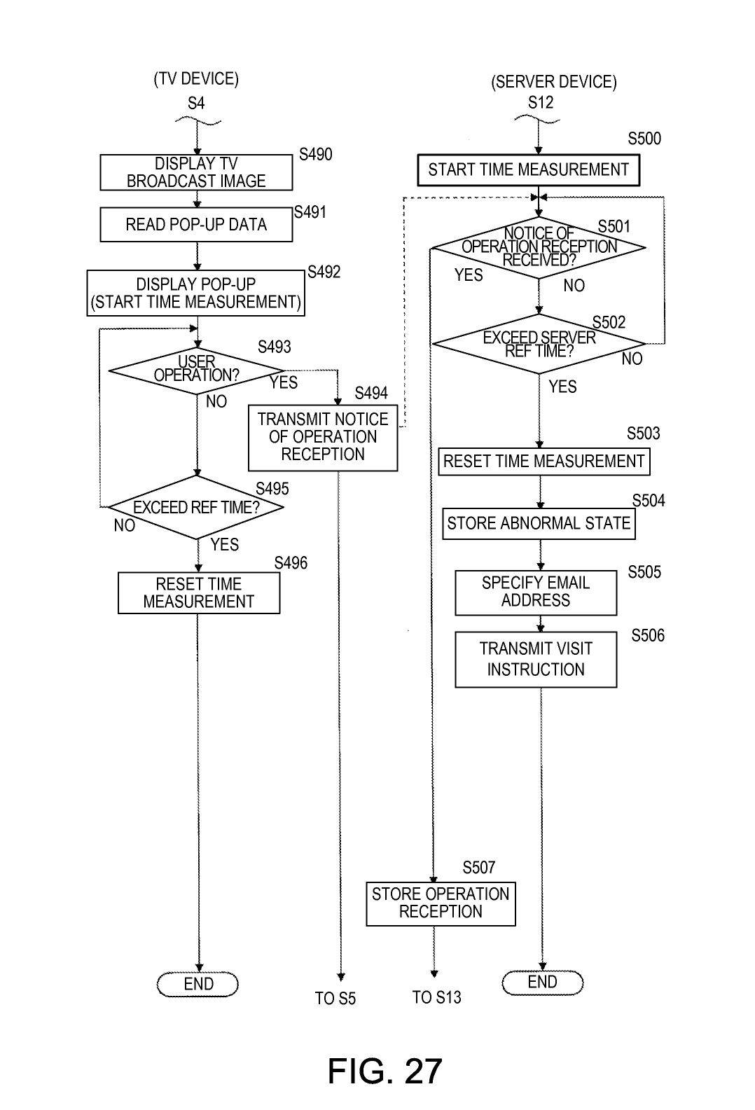

Moreover, a tenth flowchart of FIG. 27 shows processing in which, in the case of continuous indication of the pop-up 51 instead of indicating repeatedly, the synchronization of the television device 10 with the server device 2 is not required. For the processing in the tenth flowchart of FIG. 27, the television device 10 stores the reference time period and the reference number of times. In the tenth flowchart of FIG. 27, the television device 10 performs processing from Step S490 to Step S496, that basically corresponds to the processing of the television device 10 from Step S90 to Step S96 in the seventh flowchart of FIG. 24, except for the omission of processing to transmit the notices to the server device 2, namely the transmission of the notice of a user abnormal state (S96).

In the meantime, for the processing in the tenth flowchart of FIG. 27, the server device 2 stores the server reference time period and the server reference number of times. In the tenth flowchart of FIG. 27, the server device 2 performs processing from Step S500 to Step S507, that basically corresponds to the processing of the server device 2 from Step S300 to Step S307 in the eighth flowchart of FIG. 25, except for the omission of processing to transmit the notices to the television device 10, namely the transmission of the notice of server reference time period excess (S303). As described above, in the processing of the tenth flowchart of FIG. 27, except for the transmission of the notice of a user operation reception (S494), the transmission of notices between the television device 10 and the server device 2 is eliminated and the synchronization processing is omitted, and accordingly, it is advantageous that unnecessary communication can be restrained at the lowest possible, and a predetermined processing can be performed by each device even in a place of poor communication environments.

Furthermore, in the fifth flowchart of FIG. 22 for the indication of the pop-up 51, the television device 10 ends the processing temporarily. However, instead of ending the processing temporarily, it is also possible that the television device 10 returns to the indication of pop-up (S62), and maintains continuous indication of the pop-up 51 even after the excess of the reference time period (server reference time period), until there is the user operation. However, in this case, every time of the excess of the reference number of times (S69: YES), the notice of a user abnormal state is transmitted to the server device (S71). Therefore, in order to avoid such a transmission, when indicating the pop-up 51 again, regardless of proceeding to Step S71 from the next time, it is preferable that the television device 10 returns to Step S62 without transmitting the notice of a user abnormal state. Note that, the continuous indication of the pop-up 51 in this manner can be applied to the sixth to tenth flowcharts of FIGS. 23 to 27, and in these cases, instead of ending the processing temporarily as shown in each of the flowcharts, the television device 10 may maintain continuous indication of the pop-up 51 until there is the user operation, by returning to the indication of pop-up in each of the flowcharts (S162, S92, S292, S362, S492).

Moreover, in the above modification, in the state that the pop-up 51 is displayed continuously even after the excess of the reference time period (server reference time period), if there is the user operation, it is also possible that the television device 10 displays question page information corresponding to a third question page, that is different from the first question page 21 and the second question page 26. As an example of the third question page, “No answer for a long time: any trouble?” is envisaged, and as optional answers to that question, “(1) Yes (Contact required),” “(2) No (absent, but the power was on all day),” “(3) No (recovered from unwell),” “(4) No: Not the answer from himself/herself (he/she is well),” etc., are envisaged, and the user selects any answer by operating the numeric buttons 20 of the remote controller 19 (see FIG. 4).

Further, as another modification, for the reference number of times used in Step S69 of the fifth flowchart of FIG. 22, two types, namely, a first reference number of times and a second reference number of times, can be provided. First, the processing as shown in the fifth flowchart is performed by using the first reference number of times, and in the case of exceeding the first reference number of times in Step S69 (S69: YES), the television device 10 returns to Step S62, and may display the pop-up with an additional text of “If you don't answer, email will be sent to the monitoring person.” Here, after indication of the pop-up with this additional text, the television device 10 performs the processing from Step S62 to Step S69, and uses the second reference number of times in Step S69.

Here, in Step S69 using the second reference number of times, if the number of repeated indications exceeds the second reference number of times (S69: YES), the television device 10 proceeds to Step S71 for the first time, and may transmit the “notice of a user abnormal state” to the server device 2. In this modification, if there is no user operation, the notice of a user abnormal state is not transmitted to the server device 2 immediately, but the pop-up including the above additional text is displayed repeatedly for several times, and if there is no answer operation nevertheless, then “notice of a user abnormal state” is transmitted to the server device 2. Therefore, the notice of abnormal state can be transmitted more prudently.

In addition, the modification of using the first reference number of times and the second reference number of times as described above, can be modified still further, and it is also possible that, after the excess of the first reference number of times but until the excess of the second reference number of times, the length of the reference time period used in Step S65 and the length of the predetermined time used in Step S70 of the fifth flowchart can be varied each time. In this case, if the assured operation of a user is expected, it is preferable to set the reference time period to be longer than a default value, and also to set the predetermined time to be shorter than a default value, so as to display the pop-up for the longest possible time. On the other hand, if it is important to wait for the answer from the user for the longest possible time, it is preferable to set the reference time period to be around the default value, and also to set the predetermined time to be longer than the default value.

Moreover, likewise the modification of indicating the pop-up 51 continuously as described above, if there is no user operation after excess of the reference time period it is possible to also maintain the continuous indication of the first question page 21, as another modification. In this modification, in the fifth flowchart of FIG. 22, after transmitting the notice of a user abnormal state (S71), instead of ending the processing temporarily, the television device 10 returns to S5 in the first flowchart of FIG. 14, and the television device 10 may maintain continuous indication of the first question page 21 until receiving the answer from the user.

However, when the first question page 21 is displayed again after excess of the reference number of times (S69: YES), regardless of proceeding to S71 from the next time, the television device 10 returns to Step S5 without transmitting “notice of a user abnormal state” to the server device 2, so as to prevent unnecessary, repeated transmissions of notice of abnormal state to the server device 2. Note that, the continuous indication of the first question page 21 in this manner can be applied to the sixth to tenth flowcharts of FIGS. 23 to 27, and in these cases, instead of ending the processing temporarily as shown in each of the flowcharts, the television device 10 may maintain continuous indication of the first question page 21 until receiving the answer from the user, by returning to Step S5 in the first flowchart of FIG. 14.

Further, in the above modification, in the state that the first question page 21 is displayed continuously, if the answer from the user is received, it is also possible that the television device 10 displays the question page information corresponding to the third question page, that is different from the first question page or the second question page. The example of the question of the third question page is similar to the modification where the pop-up 51 is continuously displayed as explained above.

Further, as another modification of the continuous indication of the first question page 21, for the reference number of times used in Step S69 of the fifth flowchart, two types, namely, the first reference number of times and the second reference number of times, can be provided. First, the processing as shown in the fifth flowchart is performed by using the first reference number of times, and in the case of exceeding the first reference number of times in Step S69 (S69: YES), instead of proceeding to Step S71, the television device 10 returns to Step S5 in the first flowchart of FIG. 14, and may display the first question page 21 with the additional text of “If you don't answer, email will be sent to the monitoring person.” Here, after indication of the first question page 21 with this additional text, the television device 10 performs the processing from Step S5 to Step S9 in the first flowchart, proceeds to the fifth flowchart, and uses the second reference number of times in Step S69.

Here, in Step S69 using the second reference number of times, if the number of repeated indications exceeds the second reference number of times (S69: YES), the television device 10 proceeds to Step S71 for the first time, and may transmit “notice of a user abnormal state” to the server device 2. In this modification, if the answer from the user is not received, the notice of a user abnormal state is not transmitted to the server device 2 immediately, but the first question page including the above additional text is displayed, and if the answer is not received nevertheless, then “notice of a user abnormal state” is transmitted to the server device 2. Therefore, the notice of abnormal state can be transmitted more prudently.

In addition, the modification of using the first reference number of times and the second reference number of times as described above, can be modified still further, and it is also possible that, after the excess of the first reference number of times but until the excess of the second reference number of times, the length of the reference time period used in Step S8 of the first flowchart and the length of the predetermined time used in Step S70 of the fifth flowchart can be varied each time. In this case, if the assured operation of a user is expected, it is preferable to change the reference time period to be longer than the default value, and also to change the predetermined time to be shorter than the default value, so as to display the first question page 21 for the longest possible time. On the other hand, if it is important to wait for the answer from the use for the longest possible time, it is preferable to set the reference time period to be around the default value, and also to change the predetermined time to be longer than the default value.

Moreover, in the second embodiment, the form of preceding output outputted prior to the first question page 21 as shown in FIG. 5(a) is not limited to the pop-up 51 as described above, and various forms can be applied as long as they are perceivable by the user (human body). For example, other than the pop-up, it is also possible to display icons, windows, etc., as long as they are perceivable visually, and it is also possible to use the preceding output by combining these indications with audio output.

Furthermore, it is also possible to use only the audio output as the preceding output. In this case, the contents of the text part 51a of the pop-up 51 is outputted with the voice, and the guide to the operation is also outputted with the voice, to indicate that the user can perform the response operation. For example, “XXX, how's your health today? Please press enter button of the remote controller” is outputted with the voice.

Moreover, if the communication terminal device used by the monitored person is not the television device 10, but the smartphone or portable phone having a vibration function, it is also possible to apply the vibration output as the preceding output in order to activate the vibration function. In this case, upon feeling the vibration, the user responds to the preceding output by operating any key, switch or button. Further, if the smartphone or portable phone having the vibration function also includes an acceleration sensor, etc., so that the motion of the smartphone or portable phone by the user can be detected, it is also possible to assign the movement of the vibrating smartphone or portable phone by the user, as the user operation in response to the preceding output. Furthermore, if the communication terminal device used by the monitored person has a light emitting part comprised of LEDs, etc., the flashing or blinking of the light emitting part can be served as the preceding output, and it is also possible to assign the operation of any key, switch or button by the user, as the operation in response to the preceding output of the light emission. Note that, in the second embodiment, the various modifications as explained in the first embodiment can also be applied.

### Third Embodiment

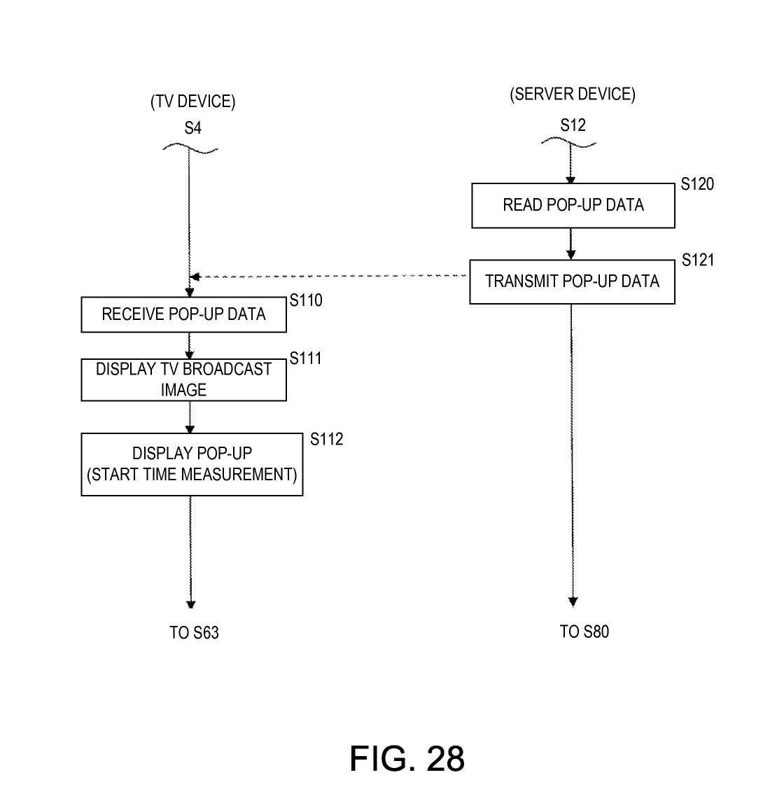

FIG. 28 is an eleventh flowchart showing substantial processing of the user state confirmation system in a third embodiment of the present disclosure. In the third embodiment of the present disclosure, instead of using the data of preceding output such as the pop-up (for example, the indication parts data such as pop-up data) stored in the television device as explained in the second embodiment, the data transmitted from the server device is used. Accordingly, in the third embodiment, the server device can control the contents of preceding output, outputted in the communication terminal device such as the television device upon the first power-on operation of the day. Therefore, various contents of the preceding output can be provided, so that the user (monitored person) is much interested in the contents, and is encouraged to perform the user operation easily. Note that, the basic structures of system and hardware in the third embodiment also correspond to the first embodiment as described above, and the same reference signs are used for those corresponding to the first embodiment, for the explanation of the third embodiment.

The server device 2 (see FIG. 8) of the third embodiment stores the indication parts data (pop-up data) for pop-up for transmitting to the television device 2, in the mass storage system 2g. There is a plurality of stored pop-up data types, and operators, etc., prepare the indication parts data regularly, including the text parts having contents in accordance with various situations such as the user condition, change of weather, social situation, etc., and adds the data to the mass storage system 2g.

As examples of the text part included in the pop-up data, stored or added to be stored in the mass storage system 2g, it is possible to include timely topics, related to the weather of yesterday such as “Heavy snowing yesterday. How's your health this morning?” or related to the result of sports game of yesterday such as “Japan National Football Team won yesterday. How's your health this morning?” Note that, the pop-up data including the contents of topics common to general users such as the weather or the result of sports game of yesterday, can be used to users (monitored persons) generally.

Moreover, it is also possible to store the pop-up data per user (user ID of the monitored person) separately so that the pop-up data includes the text part according to the contents (contents of answer, power-off time, etc.) accumulated in the answer DB 6. For example, if the answer of the user yesterday was “Good,” it is possible to reflect the contents of the answer yesterday on the data, such as “As yesterday, do you feel good?” Further, if the last power-off time of the television device yesterday was 23:52 and this is later than the average time of the user, it is also possible to display the contents corresponding to the power-off time yesterday, such as “You have watched TV till late yesterday? How's your health this morning?”

The pop-up data of the third embodiment includes control statement data, other than the data of the text part and the description data of the pop-up 51 (the data of the button 51b, the data for describing the background part, etc.). The contents of the control statement data include the time for indicating the pop-up 51 (indication time), the time until indicating the next pop-up (interval time), and the number of repeats of indication/pause (number of repeats), and the indication and pausing of output are defined in accordance with these values.

Moreover, among the indication time, the interval time and the number of repeats included in the control statement data, for the indication time and the number of repeats, it is possible to use the values equivalent to the reference time period (for example, a desired value between about 5 sec. and 3 min.) and the reference number of times (for example, a desired value between about 1 time and 15 times) as described in the second embodiment. Moreover, the interval time corresponds to the predetermined time in Step S70 of the fifth flowchart of FIG. 22, and a desired value can be set between about 1 sec. and 3 min.

For the purpose of indicating the pop-up 51 based on the pop-up data of the third embodiment, when the server device 2 receives the first power-on information, the predetermined pop-up data is read from the mass storage system 2g, and is transmitted to the television device 10 as the origin of transmission of the first power-on information, as the reply to the first power-on information. Note that, the user DB 5 can identify a communication address of the television device 10 as the origin of transmission, by using the device identifier information and the user ID transmitted to the server device 2 together with the first power-on information. The watching service program 4 stored in the mass storage system 2g has the program contents in which the definition of above processing performed by the MPU 2a is added to the second embodiment.

Note that, as examples of the reading of the pop-up data from the mass storage system 2g, selecting from the data available for the users in general, selecting from the data stored per user, or selecting from the all categories without distinguishing the both, etc., are envisaged, and the suitable reading type is chosen depending on the specifications of the watching service program 4 (the specifications of the user state confirmation system). Except for the structure as described above, the server device 2 of the third embodiment corresponds to that of the first and second embodiments.

Moreover, upon receiving the pop-up data as described above, the television device 10 of the third embodiment displays the pop-up 51 by using the received pop-up data. Therefore, the watching program P2 of the television device 10 does not read the pop-up data stored in the memory 15, but instead, the controller 14 defines processing to display the pop-up 51 based on the received pop-up data. Moreover, in the third embodiment, different from the second embodiment, the television device 10 does not need to store the pop-up data, the reference time period and the reference number of times in the memory 15. Except for the structure as described above, the television device 10 of the third embodiment corresponds to that of the first and second embodiments.

The linked processing of the television device 10 and the server device 2 in the third embodiment is explained with reference to the eleventh flowchart of FIG. 28. Note that, likewise the case of the fifth to eighth flowcharts in the second embodiment, the eleventh flowchart is also added to the first flowchart of FIG. 14 in the first embodiment.

First, after S12 is YES (the received power-on information is the first power-on information; see FIG. 14), the server device 2 reads a predetermined pop-up data from the mass storage system 2g in accordance with the defined contents of the watching service program 4 (S120), and transmits the read pop-up data to the communication address of the origin of transmission of the first power-on information (S121). Thereafter, further processing of the server device 2 is similar to the processing of Step S80 and the subsequent processing in the fifth flowchart of FIG. 22 of the second embodiment and, thus, the explanation is omitted.

In the meantime, the television device 10 receives the pop-up data transmitted from the server device 2 (S110), tunes in to the channel at the time of the last power-off operation, and displays the TV broadcast video images on the display screen 10a (S111). Here, the pop-up 51 is generated based on the received pop-up data, and emerges from the lower right corner of the display screen 10a, superimposing on the indicating broadcast video images (S112). Thereafter, further processing of the television device 10 is substantially the same as the processing of Step S63 and the subsequent processing in the fifth flowchart of FIG. 22 of the second embodiment. However, the value of time indication transmitted from the server device 2 is used for the reference time period in Step S65, the value of number of repeats transmitted from the server device 2 is used for the reference number of times in S69, and the value of interval time transmitted from the server device 2 is used for the predetermined time in Step S70.

As described above, in the user state confirmation system of the third embodiment, it is advantageous that the server device 2 can control the contents, the indication time, the number of intervals and the number of repeats of the pop-up 51, and the pop-up 51 can be indicated in various forms. Note that, various modifications can also be applied to the third embodiment. For example, it is possible that the pop-up data 51 transmitted from the server device 2 does not include the indication time, the number of intervals and the interval time, and instead, the television device 10 includes the reference time period, the reference number of times and the predetermined time corresponding thereto, likewise the case of the second embodiment so as to perform the processing. In this modification, it is advantageous that, since the user can set the reference time period, the reference number of times and the predetermined time, the user is controllable of the type of pop-up indication.

Moreover, various modifications as explained in the first embodiment and the second embodiment can also be applied to the third embodiment. For example, the processing as shown in the sixth to eighth flowcharts of FIGS. 23 to 25 of the second embodiment can be applied. When the sixth flowchart of FIG. 23 is applied, in FIG. 28, “To S63” of the television device 10 is replaced by “To S163,” and “To S80” of the server device 2 is replaced by “To S180.” Similarly, when the seventh flowchart of FIG. 24 is applied, in FIG. 28, “To S63” of the television device 10 is replaced by “To S93,” and “To S80” of the server device 2 is replaced by “To S100.” Also, when the eighth flowchart of FIG. 25 is applied, in FIG. 28, “To S63” of the television device 10 is replaced by “To S293,” and “To S80” of the server device 2 is replaced by “To S300.”

### Fourth Embodiment

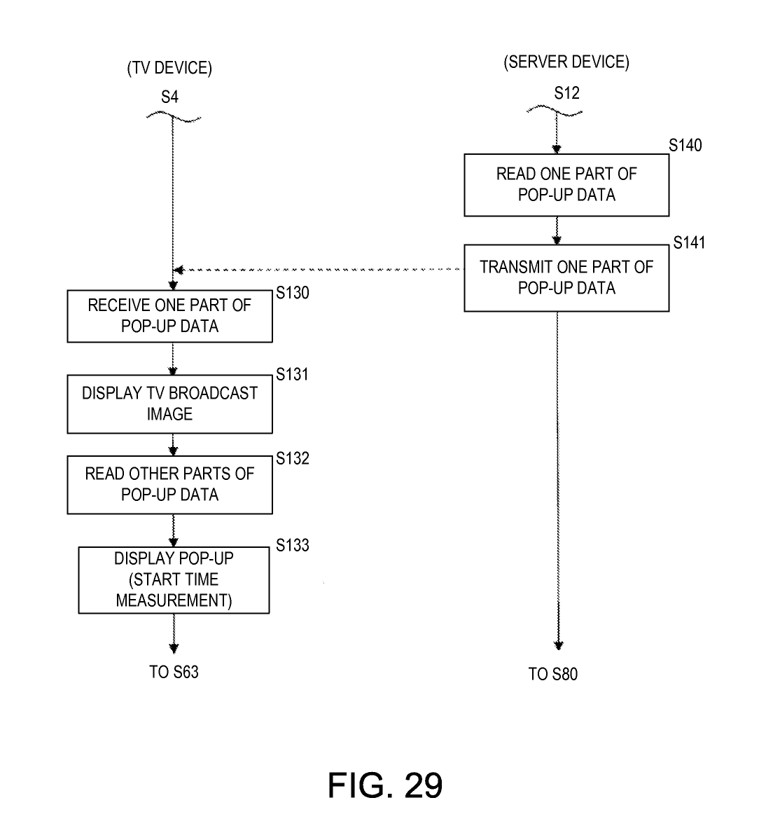

FIG. 29 is a twelfth flowchart showing substantial processing of the user state confirmation system in a fourth embodiment of the present disclosure. In the fourth embodiment of the present disclosure, the preceding output such as the pop-up is outputted by combining the processing of the second embodiment with the processing of the third embodiment, so that the preceding output can be outputted in various forms. Note that, the basic structures of system and hardware in the fourth embodiment also correspond to the first embodiment as described above, and the same reference signs are used for those corresponding to the first embodiment, for the explanation of the fourth embodiment.

In the fourth embodiment, the server device 2 stores a part of the contents of the pop-up 51 as shown in FIGS. 21(a) and (b), and the television device 10 stores another part thereof. Specifically, and first, the pop-up 51 includes a plurality of elements, such as the text part 51a, the button 51b, the description data of the background part, etc., and further, the text part 51a also includes a plurality of elements depending on the contents of the text. Therefore, the server device 2 stores, as the text part in the plurality of elements constituting the pop-up 51, data of a variable part varying in accordance with various situations, such as the user condition, change of weather, social situation, etc. On the other hand, the television device 10 stores data of a fixed part in the plurality of elements.

In particular, if the contents of the text part 51a of the pop-up 51 is “Heavy snowing yesterday. How's your health this morning?,” the part of “Heavy snowing yesterday” responds to the variable part, and the part of “How's your health this morning?” responds to the fixed part. In this case, the server device 2 stores the text data of the variable part as described above, as the part of the pop-up data, in the mass storage system 2g (see FIG. 8), and the television device 10 stores the text data of the fixed part as described above, in the watching service display table T2 of the memory 15 (see FIG. 3).

The server device 2 generates and stores, as the data of the variable part, other than the data of “Heavy snowing yesterday,” the data such as “Japan National Football Team won yesterday,” and also the data per user, such as “As similar to yesterday” and “You watched TV till late yesterday?” similar to the third embodiment as described above. Here, the watching service program 4, stored in the mass storage system 2g of the server device 2, defines processing to transmit the data of the variable part to the television device 10 as described above, similar to the third embodiment as described above. Note that, except for the structure as described above, the server device 2 of the fourth embodiment corresponds to that of the first to third embodiments.

In the meantime, the television device 10 stores, the text data of the fixed part of the text part 51a as described above, the button 51b and the description data of the background part, etc., as the other part of the pop-up data, in the watching service display table T2 of the memory 15 (see FIG. 3). Moreover, the television device 10 also stores the reference time period, the reference number of times, etc., in the memory 15 likewise the case of the second embodiment. Further, upon receiving the part of the pop-up data transmitted from the server device 2, the watching program P2 of the television device 10 defines processing to read the other part of the pop-up data from the memory 15, to generate the pop-up 51 by combining the received part with the read, other part, and to control the indication output by the controller 14. Note that, except for the structure as described above, the television device 10 of the fourth embodiment corresponds to that of the first to third embodiments.

Next, the linked processing of the television device 10 and the server device 2 in the fourth embodiment is explained with reference to a twelfth flowchart of FIG. 29. Note that, likewise the case of the fifth and sixth flowcharts in the second embodiment and the eleventh flowchart in the third embodiment, the twelfth flowchart is also added to the first flowchart of FIG. 14 in the first embodiment.

First, after Step S12 is YES (the received power-on information is the first power-on information; see FIG. 14), the server device 2 reads a part of a predetermined pop-up data from the mass storage system 2g in accordance with the defined contents of the watching service program 4 (S140), and transmits the read part of the pop-up data to the communication address of the origin of transmission of the first power-on information (S141). Thereafter, further processing of the server device 2 is similar to the processing of S80 and the subsequent processing in the fifth flowchart of FIG. 22 of the second embodiment and, thus, the explanation is omitted.

In the meantime, the television device 10 receives the part of the pop-up data transmitted from the server device 2 (S130), tunes in to the channel at the time of the last power-off operation, and displays the broadcast video images on the display screen 10a (S131). Further, upon receiving the part of the pop-up data as described above, the television device 10 reads the other part of the pop-up data from the memory 15 (S132), and generates the pop-up 51 based on the received part of the data and the read, other part of the data, so that the pop-up 51 emerges from the lower right corner of the display screen 10a, superimposing on the indicating broadcast video images (S133). Thereafter, further processing of the television device 10 is substantially the same as the processing of Step S63 and the subsequent processing in the fifth flowchart of FIG. 22 of the second embodiment and, thus, the explanation is omitted.

As described above, in the user state confirmation system of the fourth embodiment, since the server device 2 stores the variable part of the pop-up 51, the server device 2 can change the contents of the variable part. Further, since the fixed part is assigned to the television part 10, the secured indication processing can be performed. Therefore, various contents of the pop-up can be provided so as to draw the attention of the user, and the stable indication output can be secured. Note that, various modifications can also be applied to the fourth embodiment. For example, it is possible that, instead of storing the reference time period, etc., by the television device 10, the server device 2 includes these values (the reference time period, the reference number of times, the indication time corresponding to the predetermined time, the number of intervals, the number of repeats) in the part of the pop-up data, and transmits them to the television device 10, likewise the case of the third embodiment as described above. In this case, the server device can control how to display the pop-up 51, likewise the case of the third embodiment.

Moreover, various modifications as explained in the first to third embodiments can also be applied to the fourth embodiment. For example, likewise the case of the third embodiment, the processing as shown in the sixth to eighth flowcharts of FIGS. 23 to 25 of the second embodiment can be applied to the fourth embodiment. When these flowcharts are applied, in FIG. 29, the replacements of “To S63” of the television device 10 and “To S80” of the server device 2 are similar to those of the third embodiment.

### INDUSTRIAL APPLICABILITY

The present disclosure is suitable to be applied for state confirmation of monitored person to be monitored remotely, through linkage of the communication terminal device of the user used on a day-to-day basis (for example, the television device 10 provided with the communication function) with the server device 2 of the cloud system for providing the watching service, without requiring the installation of various monitoring sensors.

### DESCRIPTION OF REFERENCE NUMERALS

1 User State Confirmation System
2 Server Device
4 Watch Service Program
5 User DB
6 Answer DB
7 Second Question DB
10 Television Device
17 Communicator
19 Remoter Controller
K1 Monitoring Person
D1 Communication Terminal
K11, K12 Actual Monitoring Persons
D11, D12 Portable Communication Terminals
M1 Monitored Person
H1 House
NW Network

1-36. (canceled)

37. A user state confirmation system comprising a server device and a communication terminal device, enabling remote confirmation of a state of a user operating the communication terminal device, through the server device receiving information of the state of the user operating the communication terminal device,
the communication terminal device including:
a transmitter configured to transmit a power-on information to the server device indicating that the power is on when a power-off state transits to a power-on state based on a power-on operation;
an outputter configured to output a first question to the user based on the power-on operation; and
a transmitter configured to transmit a first response information to the server device indicating a response from the user to the outputted first question, and
the server device including:
a memory configured to store the power-on information associated with date and time of reception at which the power-on information is received;
a memory configured to store the first response information associated with date and time of reception at which the first response information is received; and
a reader/outputter configured to read and output stored information.

38. A method of confirming a user state, enabling confirmation of a state of the user operating an external communication terminal device, through a server device receiving information of the state of the user operating the external communication terminal device, the method comprising, by the server device,
a step of storing power-on information associated with date and time at which the power-on information is received, when the power-on information, indicating that the power is on, transmitted from the external communication terminal device is received;
a step of storing first response information associated with date and time at which the first response information is received, when the first response information, indicating a response from the user to a first question, transmitted from the external communication device is received; and
a step of reading and outputting stored information.

39. The method of confirming the user state of claim 38, wherein the server device stores a plurality of second question candidates, comprising, by the server device:
a step of selecting a second question candidate from the plurality of second question candidates based on the received first response information;
a step of reading and transmitting the selected second question candidate, as a second question, to the external communication terminal device; and
a step of storing second response information associated with date and time at which the second response is received, when the second response information, indicating a response from the user to the second question, transmitted from the external communication terminal device is received in response to the transmission of the second question.

40. The method of confirming the user state of claim 38, wherein the server device stores the first question, comprising, by the server device:
a step of reading and transmitting the stored first question to the external communication terminal device when the power-on information is received.

41. The method of confirming the user state of claim 39, wherein the server device stores the first question, comprising, by the server device:
a step of reading and transmitting the stored first question to the external communication terminal device when the power-on information is received.

42. The method of confirming the user state of claim 38, wherein the server device stores some parts of the first question, comprising, by the server device:
a step of reading and transmitting the stored the some parts of the first question to the external communication terminal device when the power-on information is received.

43. The method of confirming the user state of claim 39, wherein the server device stores some parts of the first question, comprising, by the server device:
a step of reading and transmitting the stored the some parts of the first question to the external communication terminal device when the power-on information is received.

44. A method of confirming a user state, enabling an external sever device to confirm a state of the user operating a communication terminal device, through the communication terminal device transmitting information on the state of the user to an external sever device, the method comprising, by the communication terminal device:
a step of transmitting power-on information to the external server device indicating that the power is on when a power-off state transits to a power-on state based on a power-on operation;
a step of outputting a first question to the user based on a power-on operation; and
a step of transmitting a first response information to the external server device indicating a response from the user to the outputted first question.

45. The method of confirming the user state of claim 44, comprising, by the communication terminal device:
a step of determining whether or not the power-on operation causing transmitting the power-on information is a first power-on operation of a day; and
a step of outputting the first question, when it is determined that the power-on operation causing transmitting the power-on information is the first power-on operation of the day.

46. The method of confirming the user state of claim 44, comprising, by the communication terminal device:
a step of outputting a preceding output capable of receiving the user responding operation prior to the first question based on the power-on operation;
a step of receiving the user responding operation on the preceding output; and
a step of outputting the first question, when the user responding operation is received.

47. The method of confirming the user state of claim 45, comprising, by the communication terminal device:
a step of outputting a preceding output capable of receiving the user responding operation prior to the first question based on the power-on operation;
a step of receiving the user responding operation on the preceding output; and
a step of outputting the first question, when the user responding operation is received.

48. The method of confirming the user state of claim 44, wherein the communication terminal device stores other parts of the first question which is different from some parts of the first question, comprising, by the communication terminal device:
a step of reading the stored the other parts of first question when the some parts of the first question are received from the external sever device; and
a step of outputting a combination of the some parts and the other parts of first question as the first question.

49. The method of confirming the user state of claim 45, wherein the communication terminal device stores other parts of the first question which is different from some parts of the first question, comprising, by the communication terminal device:
a step of reading the stored the other parts of first question when the some parts of the first question are received from the external sever device; and
a step of outputting a combination of the some parts and the other parts of first question as the first question.

50. The method of confirming the user state of claim 46, wherein the communication terminal device stores other parts of the first question which is different from some parts of the first question, comprising, by the communication terminal device:
a step of reading the stored the other parts of first question when the some parts of the first question are received from the external sever device; and
a step of outputting a combination of the some parts and the other parts of first question as the first question.

51. The method of confirming the user state of claim 47, wherein the communication terminal device stores other parts of the first question which is different from some parts of the first question, comprising, by the communication terminal device:
a step of reading the stored the other parts of first question when the some parts of the first question are received from the external sever device; and
a step of outputting a combination of the some parts and the other parts of first question as the first question.

52. A method of displaying watching information including information indicating a state of a monitored person, the method comprising, by the communication terminal device:
a step of determining whether or not a log-in operation is performed with inputting an ID of a watching side and a password;
a step of transmitting the ID of the watching side and the password inputted at the log-in operation, when it is determined that the log-in operation is performed;
a step of receiving the watching information including information a state on a plurality of monitored persons with time and date in response to transmitting the ID of the watching side and the password; and
a step of displaying the received watching information;
wherein the time and date correspond to a latest state of the monitored person, with prescribing the time of transmitting the ID of the watching side and the password as a reference.
